(19) United States
(12) Patent Application Publication
(10) Pub. No.: US 2020/0050565 A1
(43) Pub. Date: Feb. 13, 2020

(54) Pattern Processor

(71) Applicant: Guobiao ZHANG, Corvallis, OR (US)

(72) Inventor: Guobiao ZHANG, Corvallis, OR (US)

(73) Assignee: HangZhou HaiCun Information Technology Co., Ltd., HangZhou (CN)

(21) Appl. No.: 16/595,462

(22) Filed: Oct. 7, 2019

Related U.S. Application Data
(63) Continuation-in-part of application No. 15/729,640, filed on Oct. 10, 2017.
Application No. 15/729,640 is a continuation-in-part of application No. 15/452,728, filed on Mar. 7, 2017.
Application No. 15/452,728 is a continuation-in-part of application No. 16/248,914, filed on Jan. 16, 2019.
Application No. 16/248,914 is a continuation-in-part of application No. 15/973,526, filed on May 7, 2018.
Application No. 15/973,526 is a continuation-in-part of application No. 15/452,728, filed on Mar. 7, 2017.
Application No. 15/452,728 is a continuation-in-part of application No. 16/249,021, filed on Jan. 16, 2019.
Application No. 16/249,021 is a continuation-in-part of application No. 15/487,366, filed on Apr. 13, 2017.

(30) Foreign Application Priority Data
Mar. 7, 2016 (CN) 201610127981.5
Mar. 3, 2017 (CN) 201710122861.0
Mar. 7, 2017 (CN) 201710130887.X
Apr. 26, 2018 (CN) 201810381860.2
Apr. 27, 2018 (CN) 201810388096.1
Dec. 10, 2018 (CN) 201811506212.1
Dec. 11, 2018 (CN) 201811508130.0
Dec. 12, 2018 (CN) 201811520357.7
Dec. 13, 2018 (CN) 201811527885.5
Dec. 13, 2018 (CN) 201811527911.4
Dec. 14, 2018 (CN) 201811528014.5
Dec. 15, 2018 (CN) 201811546476.X
Dec. 15, 2018 (CN) 201811546592.1
Jan. 2, 2019 (CN) 201910002944.5
Jan. 3, 2019 (CN) 201910029523.1
Jan. 13, 2019 (CN) 201910029515.7

(51) Int. Cl. G06F 13/20; H04L 29/06; G06F 21/56; G06F 16/2455; G06F 3/06; G10L 15/22; G10L 15/183; G06K 9/46

(52) U.S. Cl. CPC G06F 13/20; H04L 63/1416; G06F 21/562; G06F 16/24558; G06K 9/46; G06F 3/0659; G06F 3/0688; G10L 15/22; G10L 15/183; G06F 3/0604

(57) ABSTRACT

To achieve a better overall performance, a preferred pattern processor offsets large latency with massive parallelism. The preferred pattern processor could be either a pattern-processor die comprising 3-D non-volatile memory (3D-NVM) arrays, or a pattern-processor doublet comprising a 3D-NVM die and a pattern-processing die bonded face-to-face. A searchable storage comprises a plurality of storage-like pattern processors, each of which not only stores data but also has in-situ searching capabilities.

### CROSS-REFERENCE TO RELATED APPLICATIONS

This application is a continuation-in-part of application “Processor for Enhancing Network Security”, application Ser. No. 15/729,640, filed Oct. 10, 2017, which is a continuation-in-part of application “Distributed Pattern Processor Comprising Three-Dimensional Memory”, application Ser. No. 15/452,728, filed Mar. 7, 2017.

This application is also a continuation-in-part of application “Monolithic Three-Dimensional Pattern Processor”, application Ser. No. 16/248,914, filed Jan. 16, 2019, which is a continuation-in-part of application “Distributed Pattern Storage-Processing Circuit Comprising Three-Dimensional Vertical Memory Arrays”, application Ser. No. 15/973,526, filed May 7, 2018, which is a continuation-in-part of application “Distributed Pattern Processor Comprising Three-Dimensional Memory”, application Ser. No. 15/452,728, filed Mar. 7, 2017.

This application is further a continuation-in-part of application “Discrete Three-Dimensional Processor”, application Ser. No. 16/249,021, filed Jan. 16, 2019.

This application is further a continuation-in-part of application “Processor Comprising Three-Dimensional Memory (3D-M) Array”, application Ser. No. 15/487,366, filed Apr. 13, 2017.

These applications claim priorities from the following Chinese patent applications:

1) Chinese Patent Application No. 201610127981.5, filed Mar. 7, 2016;

2) Chinese Patent Application No. 201710122861.0, filed Mar. 3, 2017;

3) Chinese Patent Application No. 201710130887.X, filed Mar. 7, 2017;

4) Chinese Patent Application No. 201810381860.2, filed Apr. 26, 2018;

5) Chinese Patent Application No. 201810388096.1, filed Apr. 27, 2018;

6) Chinese Patent Application No. 201811506212.1, filed Dec. 10, 2018;

7) Chinese Patent Application No. 201811508130.0, filed Dec. 11, 2018;

8) Chinese Patent Application No. 201811520357.7, filed Dec. 12, 2018;

9) Chinese Patent Application No. 201811527885.5, filed Dec. 13, 2018;

10) Chinese Patent Application No. 201811527911.4, filed Dec. 13, 2018;

11) Chinese Patent Application No. 201811528014.5, filed Dec. 14, 2018;

12) Chinese Patent Application No. 201811546476.X, filed Dec. 15, 2018;

13) Chinese Patent Application No. 201811546592.1, filed Dec. 15, 2018;

14) Chinese Patent Application No. 201910002944.5, filed Jan. 2, 2019;

15) Chinese Patent Application No. 201910029515.7, filed Jan. 13, 2019;

16) Chinese Patent Application No. 201910029523.1, filed Jan. 13, 2019,

in the State Intellectual Property Office of the People's Republic of China (CN), the disclosures of which are incorporated herein by references in their entireties.

### BACKGROUND

### 1. Technical Field of the Invention

The present invention relates to the field of integrated circuit, and more particularly to pattern processor.

### 2. Prior Art

A pattern processor is a device for performing pattern processing. Pattern processing includes pattern matching and pattern recognition, which are the acts of searching a target pattern (i.e. the pattern to be searched, e.g. a network packet, a digital file) for the presence of the constituents or variants of a search pattern (i.e. the pattern used for searching, e.g. a virus pattern, a keyword). The match usually has to be “exact” for pattern matching, whereas it could be “likely to a certain degree” for pattern recognition. As used hereinafter, search patterns and target patterns are collectively referred to as patterns; a pattern database (also known as a pattern library) includes a plurality of related patterns, it could be a search-pattern database (also known as search-pattern library, e.g. a virus library, a keyword library) or a target-pattern database (also known as target-pattern library, e.g. a database or an archive).

Pattern processing has broad applications. Typical pattern processing includes code matching, string matching (also known as text matching, or keyword search), speech recognition and image recognition. Code matching is widely used in information security. Its operations include searching a virus pattern in a network packet or a digital file; or, checking if a network packet or a digital file conforms to a set of rules. String matching is widely used in big-data analytics. Its operations include searching a keyword in a digital file. Speech recognition identifies from the audio data the nearest acoustic/language model in an acoustic/language model library. Image recognition identifies from the image data the nearest image model in an image model library.

The pattern database has become large: the search-pattern library (e.g. a virus library, a keyword library, an acoustic/language model library, an image model library) is already big; while the target-pattern database (e.g. a collection of digital files, a big-data database/archive, an audio database/archive, an image database/archive) is even bigger. The conventional processor and its associated von Neumann architecture have great difficulties to perform fast pattern processing on large pattern databases.

U.S. Patent App. No. 2017/0061304 filed by Van Lunteren et al. discloses a three-dimensional (3-D) chip-based regular expression scanner (hereinafter Van Lunteren). It is a pattern scanner comprising an FPGA logic layer (i.e. an FPGA die), a fabric layer (i.e. a fabric die) and four memory array layers (i.e. four eDRAM dice). All four eDRAM dice are vertically linked together by through-silicon vias (TSV's). Each eDRAM die contains 8*8=64 eDRAM clusters, with each eDRAM cluster containing 4*4=16 eDRAM blocks (also known as eDRAM arrays). Each eDRAM cluster and the associated FPGA segment form a storage-processing unit (SPU). This type of integration is generally referred to as 3-D packaging.

For the pattern scanner of Van Lunteren, an eDRAM die has a typical thickness of ˜50 micrometers. To penetrate through the eDRAM die, the TSV's have a typical size of ˜5 micrometers and a typical spacing of ˜10 micrometers. Compared with the critical dimension (˜20 nanometers) of the eDRAM, these TSV's occupy significant silicon real estate. Adding the fact that each eDRAM cluster has a relatively large footprint, the pattern scanner of Van Lunteren offers a limited parallelism of 64, i.e. 64 SPU's are running in parallel.

The eDRAM in the pattern scanner of Van Lunteren is a volatile memory. Because its data will be lost once power goes off, the volatile memory cannot be used as a long-term data store. Data have to be stored elsewhere for long term, e.g. in an external storage (which is non-volatile, e.g. a storage card or a solid-state drive) (Van Lunteren, FIG. 5, [0050]). Hence, the Van Lunteren's system comprises a pattern scanner and an external storage. Because the pattern-processing throughput of the Van Lunteren's system is limited by the bandwidth between the external storage and the pattern scanner, the pattern-processing time (e.g. search time) for the whole external storage is proportional to its capacity. For a large storage capacity, the pattern-processing time ranges from minutes to hours, or even longer.

U.S. Patent App. No. 2004/0012053 filed by Zhang discloses a 3-D integrated memory (hereinafter Zhang), which is a monolithic die comprising 3-D memory (3D-M) arrays vertically integrated with an embedded processor. The 3D-M array(s) and the processor are communicatively coupled with ISP-connections, e.g. contact vias. This type of integration is generally referred to as 3-D integration. As its degree of parallelism is not specified (FIG. 2B of Zhang shows only a single SPU, equivalent to a parallelism of one), the 3-D integration of Zhang is referred to as simple 3-D integration.

The simple 3-D integration (Zhang) would have a poorer overall performance than the 3-D packaging (e.g. Van Lunteren) for the following reason. The active elements (i.e. memory cells) of the 3D-M array are made of non-single-crystalline (e.g. poly-crystalline or amorphous) semiconductor material, i.e. they do not comprise any single-crystalline semiconductor material. On the other hand, the active elements (i.e. transistors in the memory cells) of the conventional two-dimensional (2-D) memory (e.g. SRAM, DRAM) are made of at least one single-crystalline semiconductor material, i.e. the memory cells comprise at least a single-crystalline semiconductor material. Because the non-single-crystalline semiconductor material has a poorer performance than the single-crystalline semiconductor material, the 3D-M would have a larger latency than the conventional 2-D memory (e.g. SRAM, DRAM).

### OBJECTS AND ADVANTAGES

It is a principle object of the present invention to improve the overall performance of pattern processing for a large pattern database.

It is a principle object of the present invention to achieve a substantially higher throughput for pattern processing.

It is a further object of the present invention to offset the large latency of the 3-D non-volatile memory (3D-NVM) with massive parallelism.

It is a further object of the present invention to enhance information security.

It is a further object of the present invention to provide an anti-virus storage.

It is a further object of the present invention to improve the overall performance of big-data analytics.

It is a further object of the present invention to provide a searchable big-data storage.

It is a further object of the present invention to improve the overall performance of speech recognition

It is a further object of the present invention to provide a searchable audio storage.

It is a further object of the present invention to improve the overall performance of image recognition.

It is a further object of the present invention to provide a searchable image storage.

In accordance with these and other objects of the present invention, the present invention discloses a pattern processor and a searchable storage.

### SUMMARY OF THE INVENTION

With low cost and long-term storage, it is desired to use a 3-D non-volatile memory (3D-NVM) (e.g. 3D-OTP, 3D-XPoint, 3D-NAND) to store patterns in a pattern processor. As disclosed in the “prior art” section, a 3-D memory generally has a larger latency than a 2-D memory. Adding the fact that a non-volatile memory (e.g. ROM) generally has a larger latency than a volatile memory (e.g. RAM), the 3D-NVM generally has a larger latency than the SRAM or DRAM used in prior art. As a result, a pattern processor based on the 3D-NVM is expected to have a poorer performance than the pattern scanner of Van Lunteren.

The present invention reverses this expectation. Because the overall performance of a pattern processor is determined by not only latency, but also throughput (Performance=Throughput/Latency), the deficiency in latency can be remedied by throughput. Accordingly, the present invention discloses a pattern processor, which offsets large latency with massive parallelism.

The preferred pattern processor comprises massive number of storage-processing units (SPU's). Each SPU comprises at least a 3-D non-volatile memory (3D-NVM) array including memory cells and storing at least a portion of a pattern; a single pattern-processing circuit disposed on a semiconductor substrate and performing pattern processing; and a plurality of inter-storage-processor (ISP) connections for communicatively coupling the 3D-NVM array and the pattern-processing circuit. The pattern-processing circuit comprises at least a single-crystalline semiconductor material. On the other hand, the memory cells of the 3D-NVM array are not in contact with and not interposed therebetween by any semiconductor substrate. Furthermore, the memory cells do not comprise any single-crystalline semiconductor material. The preferred pattern processor could be either a singlet (i.e. it is a single die comprising monolithically integrated 3D-NVM arrays and the pattern-processing circuits) or a doublet (i.e. it comprises two dice, a 3D-NVM die and a pattern-processing die, bonded face-to-face).

A key difference between the present invention and prior art (e.g. Van Lunteren) is that the ISP-connections do not penetrate through any semiconductor substrate. Because of this, the ISP-connections are generally short in length. In one preferred embodiment, the length of each ISP-connection is on the order of one micrometer. In comparison, to penetrate four semiconductor substrates (i.e. four eDRAM dice), the TSV's in Van Lunteren are ˜200 micrometers long. Furthermore, short ISP-connections lead to small ISP-connections. In one preferred embodiment, the dimension (e.g. the diameter) of each ISP-connection is smaller than one micrometer. For example, the diameter of each contact via in FIG. 3 could be ˜40 nanometers. In comparison, the TSV's in Van Lunteren are at least five micrometers in diameter and ten micrometers in spacing. Moreover, because the ISP-connections are small, each SPU generally comprises a larger number of ISP-connections. In one preferred embodiment, each SPU comprises at least one thousand ISP-connections; and, for the preferred pattern processor (either singlet or doublet), the total number of the ISP-connections could reach one million and even more. With a large number of the ISP-connections, the preferred pattern processor can achieve a large bandwidth between the 3D-NVM array and the pattern-processing circuit. More importantly, small memory cells and small ISP-connections lead to small SPU's and therefore, the preferred pattern processor comprises massive number of SPU's. In one preferred embodiment, a pattern processor comprises at least one thousand SPU's. In another preferred embodiment, a pattern processor comprises at least ten thousand SPU's. Because these SPU's perform pattern processing simultaneously, the preferred pattern processor supports massive parallelism. With massive parallelism, the type of the 3-D integration employed in the present invention is referred to as massive 3-D integration.

The preferred pattern processor of the present invention comprises substantially more SPU's than the pattern scanner of Van Lunteren. For example, a 128 gigabit 3D-XPoint, containing 64,000 3D-XPoint arrays, can achieve a degree of parallelism of up to 64,000. In comparison, for Van Lunteren, because an eDRAM array has a much larger footprint than a 3D-NVM array and the TSV's occupy significant area, the SPU of the pattern scanner has a much larger footprint. As a result, the pattern scanner only achieves a degree of parallelism of 64 (Van Lunteren, [0044]). Apparently, this difference in the degree of parallelism is large enough to compensate the difference in latency between 3D-XPoint and eDRAM.

Accordingly, the present invention discloses a pattern processor, comprising an input bus for transferring at least a first portion of a first pattern and at least one thousand storage-processing units (SPU's) communicatively coupled with said input bus, each of said SPU's comprising: at least a three-dimensional non-volatile memory (3D-NVM) array including memory cells and storing at least a second portion of a second pattern, wherein said memory cells are not in contact with and not interposed therebetween by any semiconductor substrate; and, said memory cells do not comprise any single-crystalline semiconductor material; a single pattern-processing circuit disposed on a semiconductor substrate and performing pattern processing for said first and second patterns, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate. Preferably, the number of the ISP-connections in each SPU is more than one thousand; and/or, the length of the ISP-connections in each SPU is on the order of one micrometer.

The present invention further discloses a searchable storage. Similar to a conventional storage (e.g. an SD card, or a solid-state storage, which comprises a plurality of flash memory dice), it comprises a plurality of storage-like pattern processors. In the context of storage, a storage-like pattern processor is referred to as a searchable 3-D memory. The primary purpose of the preferred searchable storage is to store data (i.e. a target-pattern database, e.g. a collection of digital files, a big-data database/archive, an audio database/archive, an image database/archive), with a secondary purpose of in-situ searching the stored data for a search pattern specified by a user. Each searchable 3-D memory stores at least a portion of data for the target-pattern database. More importantly, each searchable 3-D memory has in-situ searching capabilities. This is different from the conventional storage, where each flash memory die is a pure memory and does not have any in-situ searching capabilities.

In a preferred searchable 3-D memory, because each SPU contains a pattern-processing circuit, the data stored in its 3D-NVM array(s) can be individually searched by the local pattern-processing circuit. No matter how large is the capacity of the target-pattern database, the search time for the whole database is similar to that for a single SPU. In other words, the search time for a large database is irrelevant to its capacity. Most searches can be completed within seconds. This is significantly faster than the conventional storage.

This speed advantage can be further viewed from the perspective of parallelism. Because each SPU has its own pattern-processing circuit, the number of the SPU's grows with the storage capacity, so does the degree of parallelism. As a result, the search time does not increase with the storage capacity. However, for the pattern scanner of Van Lunteren, because the number of the SPU's and the degree of parallelism are fixed, the search time increases with the storage capacity.

Besides a substantial speed advantage, the preferred searchable storage provides a substantial cost advantage. The peripheral circuits of the 3D-NVM arrays and the pattern-processing circuit are formed on a substrate underneath or above the 3D-NVM arrays. Because the peripheral circuits of the 3D-NVM arrays only occupy a small portion of the substrate area, most substrate area can be used to form the pattern-processing circuits. As the peripheral circuits of the 3D-NVM arrays need to be formed anyway, the pattern-processing circuits can piggyback on the peripheral circuits, i.e. they can be manufactured at the same time with the peripheral circuits. Hence, inclusion of the pattern-processing circuits adds little or no extra cost to the preferred searchable storage. In prior art, inclusion of the pattern-processing circuits require an extra die (e.g. Van Lunteren) or an extra die area, both of which increase cost.

The preferred searchable storage provides with a substantial speed advantage (i.e. search time does not increase with capacity) and a substantial cost advantage (i.e. the in-situ searching capabilities does not incur extra cost). Accordingly, the present invention discloses a searchable storage, comprising an input bus for transferring at least a search pattern and a plurality of searchable 3-D memories, each of said searchable 3-D memories including a plurality of storage-processing units (SPU's) communicatively coupled with said input bus, each of said SPU's comprising: at least a three-dimensional non-volatile memory (3D-NVM) array including memory cells and storing at least a portion of data, wherein said memory cells are not in contact with and not interposed therebetween by any semiconductor substrate; and, said memory cells do not comprise any single-crystalline semiconductor material; a pattern-processing circuit disposed on a semiconductor substrate and performing pattern processing for said search pattern and said portion of data, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate; whereby the primary purpose of said searchable storage is long-term data storage and the secondary purpose of said searchable storage is in-situ search.

Due to layout constraints, the pattern-processing circuit in the preferred searchable storage has limited functionalities. The preferred searchable storage preferably works with an external processor for full pattern processing. Accordingly, the present invention discloses a storage system comprising a searchable storage and a standalone processor. The standalone processor could be a full-power processor which can perform full pattern processing. It could be a CPU, a GPU, an FPGA, an AI processor, or others. The pattern-processing circuit in the preferred searchable storage performs preliminary pattern processing. After this preliminary pattern-processing step, data are output to the standalone processor to perform full pattern processing. Because the amount of the data output from the preferred searchable storage is substantially smaller than the amount of the data stored in the preferred searchable storage, the data transfer places less burden on the system bus between the searchable storage and the standalone processor. With much less data to process, the full pattern processing, even for the full searchable storage, takes less time and becomes more efficient.

Accordingly, the present invention discloses a storage system, comprising a standalone processor and a searchable storage, wherein said searchable storage comprises a plurality of searchable 3-D memories, comprising an input bus for transferring at least a search pattern and a plurality of searchable 3-D memories, each of said searchable 3-D memories including a plurality of storage-processing units (SPU's) communicatively coupled with said input bus, each of said SPU's comprising: at least a three-dimensional non-volatile memory (3D-NVM) array including memory cells and storing at least a portion of data, wherein said memory cells are not in contact with and not interposed therebetween by any semiconductor substrate; and, said memory cells do not comprise any single-crystalline semiconductor material; a pattern-processing circuit disposed on a semiconductor substrate and performing preliminary pattern processing for said search pattern and said portion of data, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate; a fraction of said portion of data is transferred to said standalone processor for full pattern processing.

### BRIEF DESCRIPTION OF THE DRAWINGS

FIG. 1A is a circuit block diagram of a preferred pattern processor; FIG. 1B is a circuit block diagram of a preferred storage-processing unit (SPU);

FIGS. 2A-2D are cross-sectional views of four preferred SPU's in four preferred pattern-processor dice;

FIG. 3 is a perspective view of a preferred SPU in a preferred pattern-processor die;

FIGS. 4A-4B are cross-sectional views of two preferred pattern-processor doublets; FIG. 4C is a cross-sectional view of a preferred 3D-NVM die in a preferred pattern-processor doublet; FIG. 4D is a cross-sectional view of a preferred pattern-processing die in the preferred pattern-processor doublet;

FIGS. 5A-5C are circuit block diagrams of three preferred SPU's;

FIGS. 6A-6C are circuit layout views of three preferred SPU's on the substrate;

FIG. 7A is a perspective view of a preferred searchable storage; FIG. 7B is its circuit block diagram; FIG. 7C is a circuit block diagram of a preferred storage system;

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments. Singular form is used to refer to both singular and plural forms. The symbol “/” means a relationship of “and” or “or”.

As used herein, the phrase “memory” is used to mean a semiconductor memory. The phrase “storage” is used in its broadest sense to mean any long-term information store. In this specification, storage is a solid-state storage which comprises a plurality of non-volatile memory (NVM). The phrase “memory array” is used in its broadest sense to mean a collection of all memory cells sharing at least an address line.

As used herein, the phrase “a circuit on a substrate” is used in its broadest sense to mean that at least some of its active elements or portions thereof (e.g. channels) are formed in the substrate, even though the interconnects coupling the active elements (e.g. transistors) and other portions of the active elements (e.g. gates) are formed above the substrate. The phrase “a circuit above a substrate” is used in its broadest sense to mean that all active elements are disposed above the substrate, not in contact with the substrate. The phrase “memory cells are interposed therebetween by a semiconductor substrate” means that a semiconductor substrate is interposed between the memory cells; in other words, there is a semiconductor substrate between the memory cells. The phrase “memory cells are not interposed therebetween by any semiconductor substrate” means that no semiconductor substrate is interposed between the memory cells; in other words, there is no semiconductor substrate between the memory cells.

As used herein, the phrases “a circuit made of single-crystalline semiconductor material” and “a circuit comprising at least a single-crystalline semiconductor material” mean that a key portion (e.g. channel) of its active elements (e.g. transistors) is formed in a single-crystalline semiconductor substrate. The phrases “a circuit made of non-single-crystalline semiconductor material”, “a circuit comprising non-single-crystalline semiconductor materials” and “a circuit does not comprise any single-crystalline semiconductor material” mean that a key portion (e.g. channel) of its active elements (e.g. transistors) is formed in a non-single-crystalline (e.g. poly-crystalline or amorphous) semiconductor film and does not comprise any single-crystalline semiconductor material.

As used herein, the phrases “performing pattern processing for a search pattern and a target pattern”, “performing pattern processing for a pattern (e.g. a search pattern, a target pattern, or both)”, “searching a target pattern for a search pattern”, “searching a search pattern in a target pattern”, “performing pattern recognition on a target pattern with a search pattern (or, a model)”, and other similar phrases have the same meaning. They are used in their broadest sense to mean pattern matching or pattern recognition between a search pattern and a target pattern.

As used herein, the phrases “diode”, “steering element”, “steering device”, “selector”, “selecting element”, “selecting device”, “selection element” and “selection device”, all have the same meaning. They are used in their broadest sense to mean a device whose resistance at the read voltage is substantially lower than when the applied voltage has a magnitude smaller than or polarity opposite to that of the read voltage.

As used herein, the phrase “communicatively coupled” is used in its broadest sense to mean any coupling whereby electrical signals may be passed from one element to another element. The phrase “pattern” could refer to either pattern per se, or the data related to a pattern, depending on the context. The phrase “image” is used in its broadest sense to mean still pictures and/or motion pictures. The phrase “database” and “library” are used interchangeably. The phrase “string-matching” and “text-matching” are used interchangeably.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

To offset the large latency of the 3-D non-volatile memory (3D-NVM) with massive parallelism, the present invention discloses a pattern processor. It comprises massive number of storage-processing units (SPU's). Because the SPU's perform pattern processing simultaneously, the preferred pattern processor supports massive parallelism.

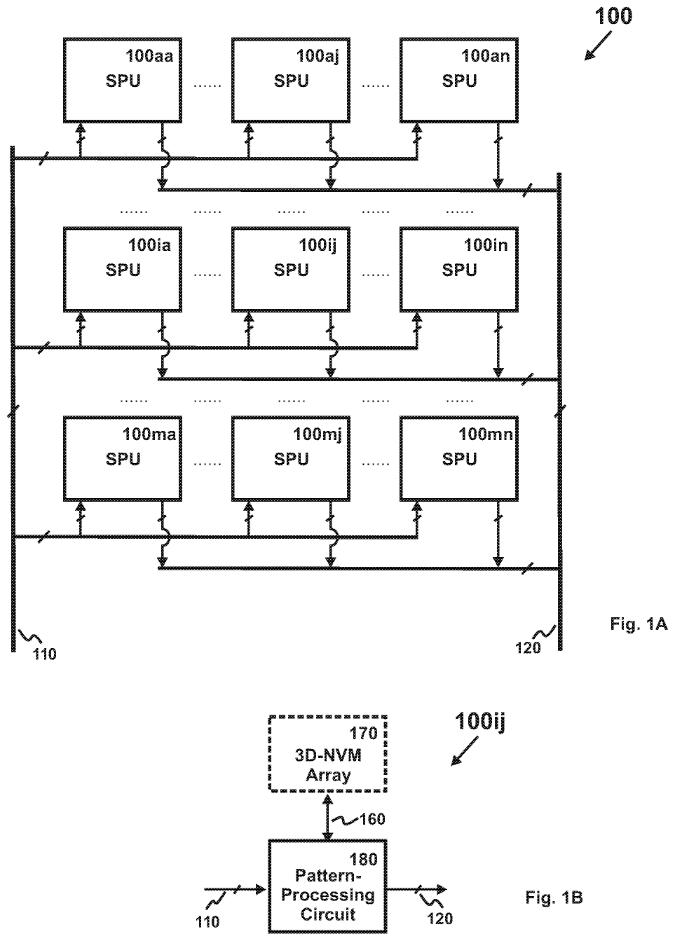

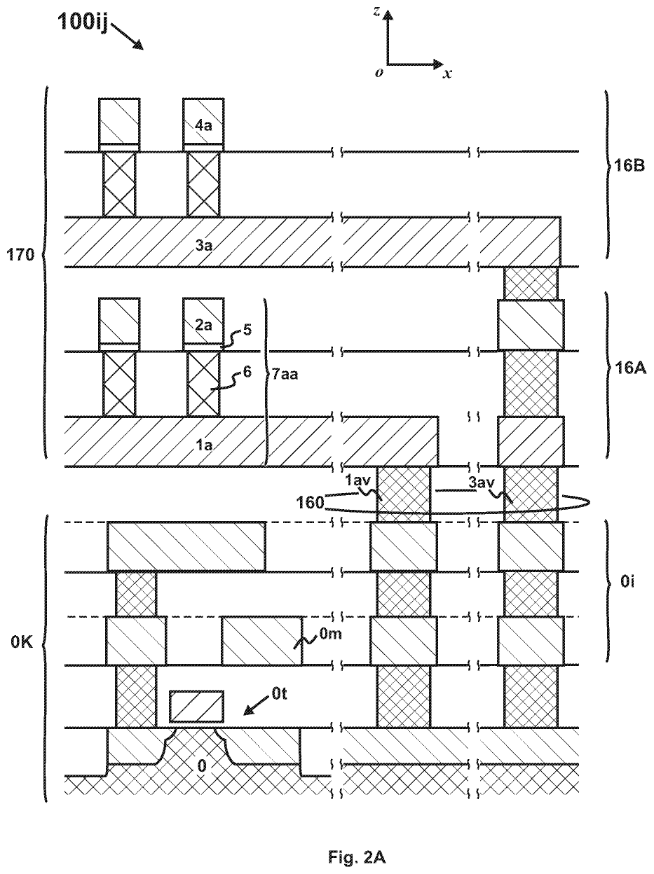

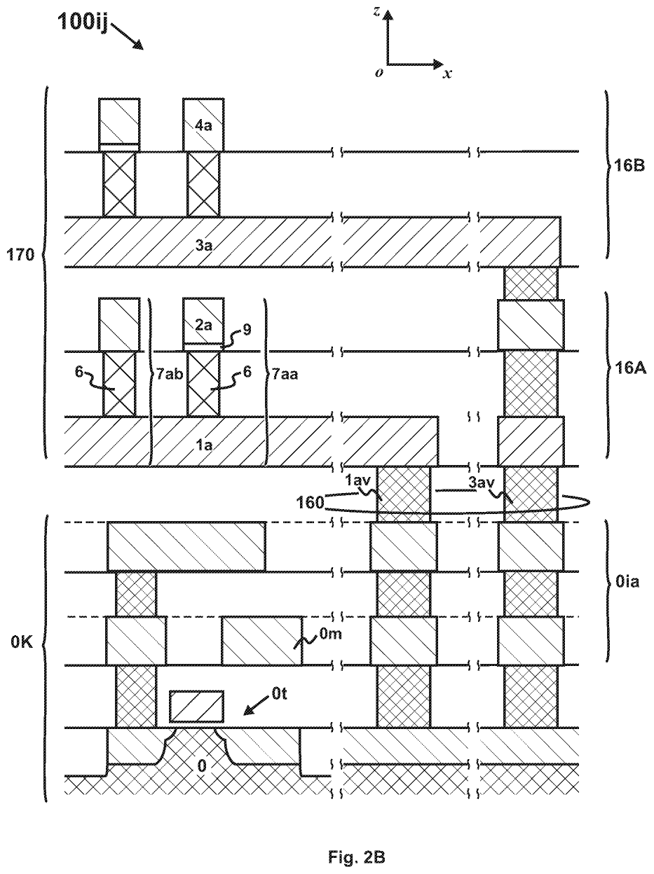

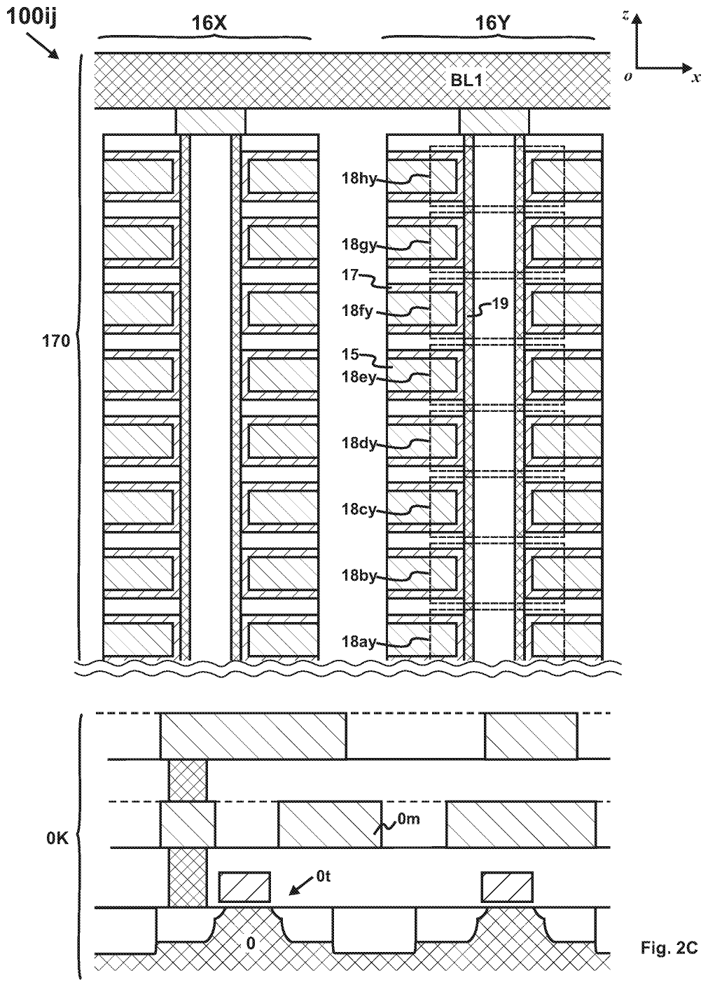

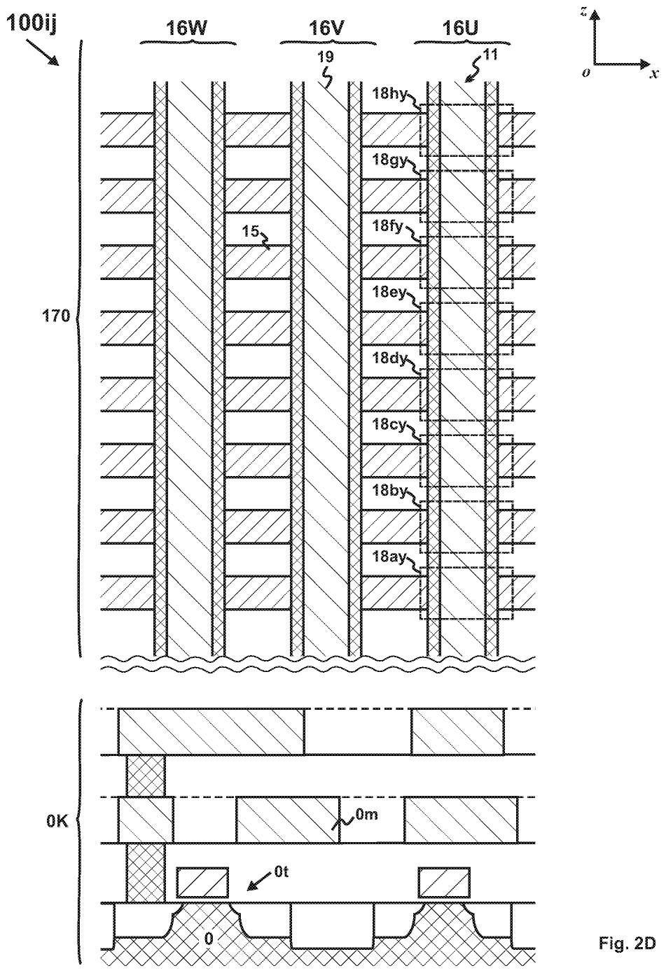

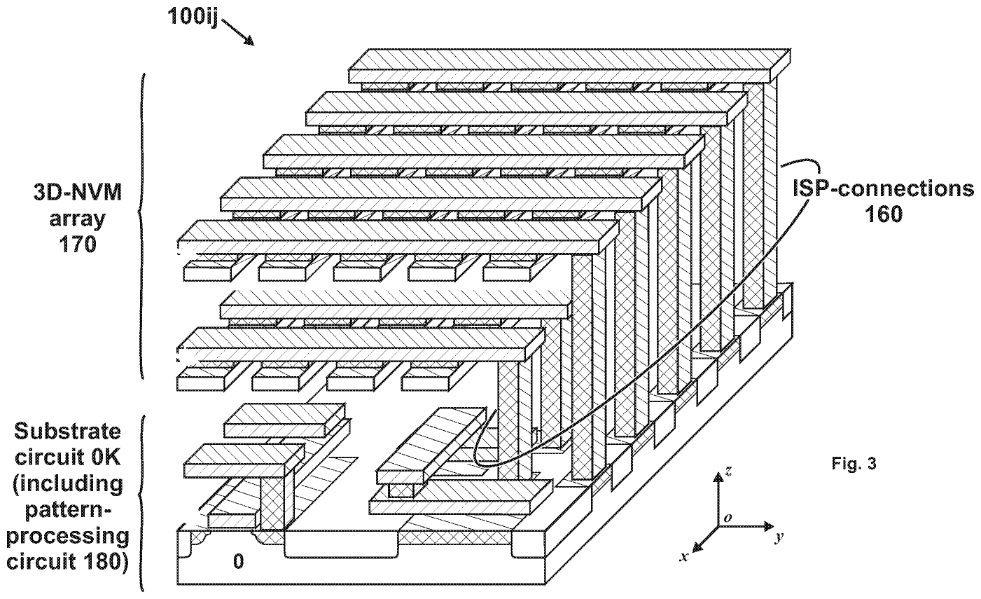

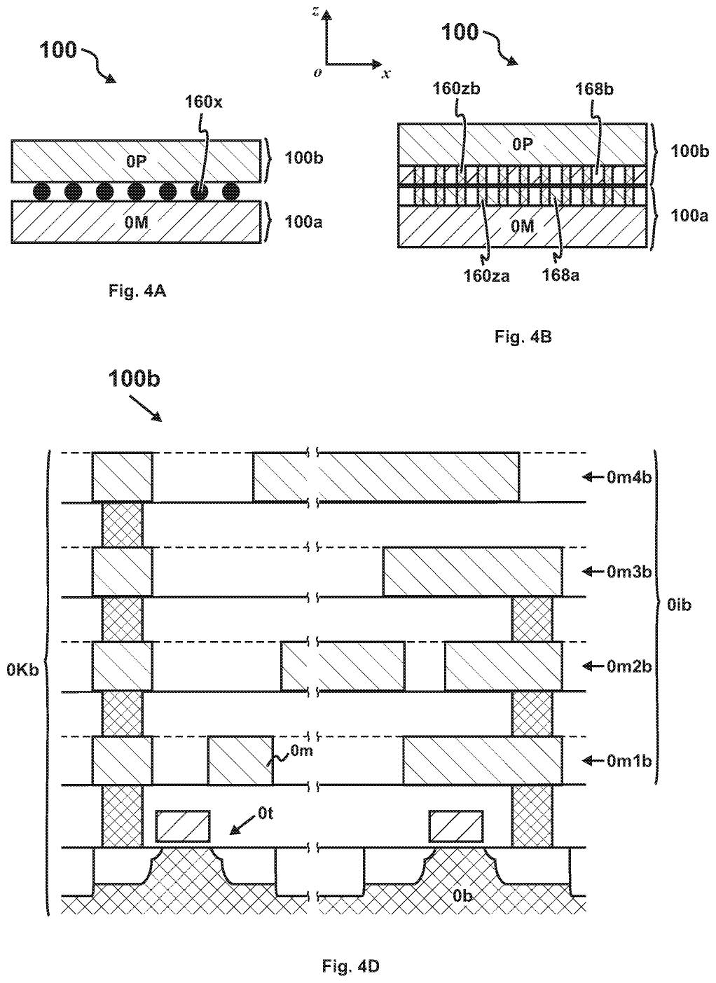

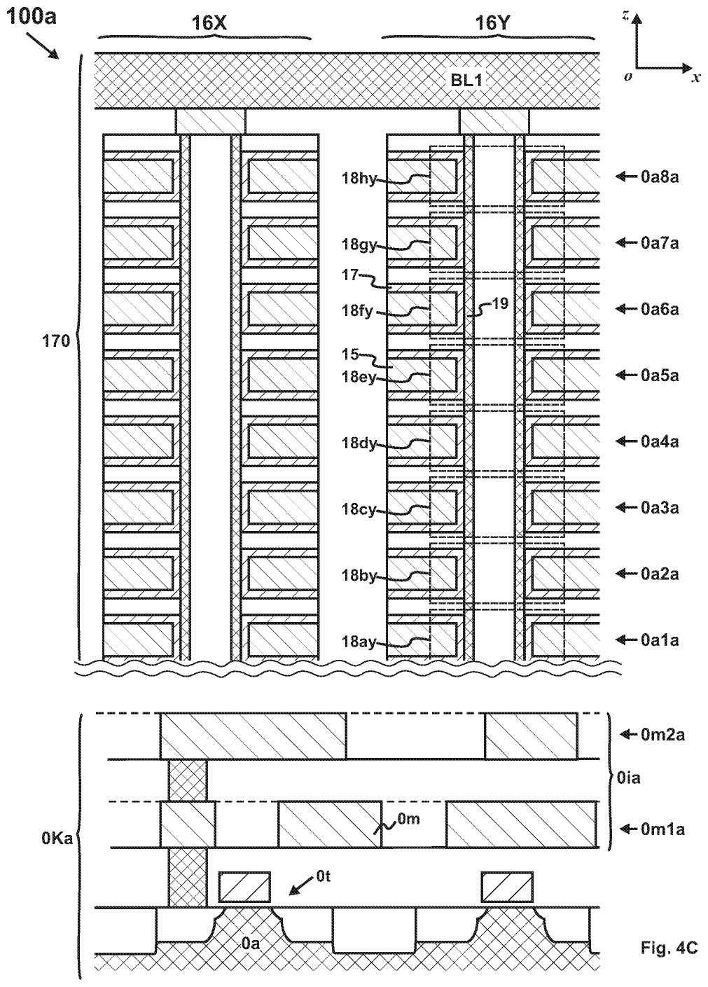

Referring now to FIGS. 1A-1B, an overview of a preferred pattern processor 100 is disclosed. The preferred pattern processor 100 could be either a pattern-processor die comprising 3-D non-volatile memory (3D-NVM) arrays (FIGS. 2A-3), or a pattern-processor doublet comprising a 3D-NVM die and a pattern-processing die bonded face-to-face (FIGS. 4A-4D). The preferred pattern processor 100 not only processes patterns, but also stores patterns. FIG. 1A is its circuit block diagram. It comprises an array with m rows and n columns (m×n) of storage-processing units (SPU's) 100aa-100mn. In one preferred embodiment, the preferred pattern processor 100 comprises at least one thousand SPU's 100aa-100mn. In another preferred embodiment, the preferred pattern processor 100 comprises at least ten thousand SPU's 100aa-100mn.

The preferred pattern processor 100 has an input bus 110 and an output bus 120. The input bus 110 is communicatively coupled with the input buses of the SPU's 100aa-100mn, whereas the output bus 120 is communicatively coupled with the output buses of the SPU's 100aa-100mn. During pattern processing, an input pattern is sent via the input bus 110 to the SPU's 100aa-100mn. Because the SPU's 100aa-100mn process the input pattern simultaneously, the preferred pattern processor 100 can achieve a parallelism of m×n. After pattern processing, the outputs from the SPU's 100aa-100mn are sent out via the output bus 120.

The preferred pattern processor 100 comprises substantially more SPU's 100aa-100mn than the pattern scanner of Van Lunteren. For example, a 128 gigabit 3D-XPoint, containing 64,000 3D-XPoint arrays, can achieve a degree of parallelism of up to 64,000. In comparison, for Van Lunteren, because an eDRAM array has a much larger footprint than a 3D-NVM array and the TSV's occupy significant area, the SPU of the pattern scanner has a much larger footprint. As a result, the pattern scanner only achieves a degree of parallelism of 64 (Van Lunteren, [0044]). Apparently, this difference in the degree of parallelism is large enough to compensate the difference in latency between 3D-XPoint and eDRAM.

FIG. 1B is a circuit block diagram of a preferred SPU 100ij. The SPU 100ij comprises a pattern-storage circuit 170 and a pattern-processing circuit 180, which are communicatively coupled by the ISP-connections 160 (referring to FIGS. 2A-4C). The pattern-storage circuit 170 comprises at least a 3D-NVM array. The 3D-NVM array 170 stores at least a portion of a pattern, whereas the pattern-processing circuit 180 processes the pattern. Because the 3D-NVM array 170 is located on a different physical level than the pattern-processing circuit 180 (referring to FIGS. 2A-4C), the 3D-NVM array 170 is drawn by dashed lines.

The preferred pattern-processing circuit 180 could be a code-matching circuit, a string-matching circuit, a speech-recognition circuit, or an image-recognition circuit. These preferred pattern-processing circuits 180 are well known to those skilled in the art. For example, the code-matching circuit or the string-matching circuit could be implemented by a content-addressable memory (CAM) or a comparator (including XOR circuits, or a distance computing unit). Alternatively, a search pattern (e.g. keyword) can be represented by a regular expression. In this case, the string-matching circuit 180 can be implemented by a finite-state automata (FSA) circuit. Compared with the speech-recognition circuit or the image-recognition circuit, the code-matching circuit and the string-matching circuit are easier to design, smaller in footprint, and can be more easily placed underneath or above few 3D-NVM array(s). With each SPU containing few 3D-NVM array(s), it would be easier to achieve a large degree of parallelism.

More details on the pattern-processing circuits are disclosed in U.S. Pat. No. 4,672,678 issued to Koezuka et al. on Jun. 9, 1987; U.S. Pat. No. 4,985,863 issued to Fujisawa et al. on Jan. 15, 1991; U.S. Pat. No. 5,140,644 issued to Kawaguchi et al. on Aug. 18, 1992; U.S. Pat. No. 5,276,741 issued to Aragon et al. on Jan. 4, 1994; U.S. Pat. No. 5,579,411 issued to Shou et al. on Nov. 26, 1996; U.S. Pat. No. 5,671,292 issued to Lee et al. on Sep. 23, 1997; U.S. Pat. No. 7,487,542 issued to Boulanger et al. on Feb. 3, 2009; U.S. Pat. No. 8,717,218 issued to Jhang et al. on May 6, 2014; U.S. Patent App. No. 2017/0061304 filed by Van Lunteren et al. on Sep. 1, 2015; and others.

In the following figures, two forms of the preferred pattern processor 100 are disclosed. The first form of the preferred pattern processor 100 is a singlet, i.e. the preferred pattern processor 100 is a pattern-processor die (FIGS. 2A-3), which comprises only a single semiconductor substrate 0. The second form of the preferred pattern processor 100 is a doublet, i.e. the pattern processor 100 is a pattern-processor doublet (FIGS. 4A-4D), which comprises two dice, a 3D-NVM die and a pattern-processing die, bonded face-to-face. Note that the preferred pattern-processor doublet 100 comprises only two semiconductor substrates 0M, 0P (FIGS. 4A-4B).

Referring now to FIGS. 2A-2D, four preferred SPU's 100ij of the preferred pattern-processor die 100 are disclosed. For these preferred embodiments, the pattern-storage circuit (i.e. 3D-NVM array) 170 and pattern-processing circuit 180 are monolithically integrated into a single pattern-processor die (singlet) 100. The pattern-processor die 100 comprises only a single semiconductor substrate 0. The pattern-processing circuit 180 is formed on the semiconductor substrate 0 and the memory cells of the 3D-NVM array 170 are vertically stacked on the pattern-processing circuit 180. Since it is formed on a single-crystalline semiconductor substrate 0, the pattern-processing circuit 180 comprises at least a single-crystalline semiconductor material. On the other hand, since that they are not in contact with or interposed therebetween by any semiconductor substrate, the memory cells of the 3D-NVM array 170 do not comprise any single-crystalline semiconductor material. Being non-volatile, the 3D-NVM array 170 keeps the data stored therein for a long term even when power goes off. It generally has a larger capacity and a lower cost, but a larger latency than the volatile memory (e.g. SRAM, DRAM). The present invention remedies this large latency by employing massive parallelism.

Based on its physical structure, the 3D-NVM can be categorized into horizontal 3D-NVM (3D-NVM_{H}) and vertical 3D-NVM (3D-NVM_{V}). In a 3D-NVM_{H}, all address lines are horizontal. The memory cells form a plurality of horizontal memory levels which are vertically stacked above each other. A well-known 3D-NVM_{H} is 3D-XPoint. In a 3D-NVM_{V}, at least one set of the address lines are vertical. The memory cells form a plurality of vertical memory strings which are placed side-by-side on/above the substrate. A well-known 3D-NVM_{V} is 3D-NAND. In general, the 3D-NVM_{H} (e.g. 3D-XPoint) is faster, while the 3D-NVM_{V} (e.g. 3D-NAND) is denser.

Based on the programming methods, the 3D-NVM can be categorized into 3-D writable memory (3D-W) and 3-D printed memory (3D-P). The 3D-W cells are electrically programmable. Based on the number of programmings allowed, the 3D-W can be further categorized into three-dimensional one-time-programmable memory (3D-OTP) and three-dimensional multiple-time-programmable memory (3D-MTP, including re-programmable). Common 3D-MTP includes 3D-XPoint and 3D-NAND. Other 3D-MTP's include memristor, resistive random-access memory (RRAM or ReRAM), phase-change memory (PCM), programmable metallization cell (PMC) memory, conductive-bridging random-access memory (CBRAM), and the like.

For the 3D-P, data are recorded into the 3D-P cells using a printing method during manufacturing. These data are fixedly recorded and cannot be changed after manufacturing. The printing methods include photo-lithography, nano-imprint, e-beam lithography, DUV lithography, and laser-programming, etc. An exemplary 3D-P is three-dimensional mask-programmed read-only memory (3D-MPROM), whose data are recorded by photo-lithography. Because a 3D-P cell does not require electrical programming and can be biased at a larger voltage during read than the 3D-W cell, the 3D-P is faster.

In FIGS. 2A-2B, the preferred pattern processor 100 comprises a substrate circuit OK and a 3D-NVM_{H} array 170 vertically stacked thereon. The substrate circuit OK includes transistors 0t and metal lines 0m. The transistors 0t are disposed on a semiconductor substrate 0. The metal lines 0m form substrate interconnects 0i, which communicatively couple the transistors 0t. The 3D-NVM_{H} array 170 includes two memory levels 16A, 16B, with the memory level 16A stacked on the substrate circuit OK and the memory level 16B stacked on the memory level 16A. Memory cells (e.g. 7aa) are disposed at the intersections between two address lines (e.g. 1a, 2a). At present, the width of the address lines (e.g. 1a, 2a) is typically smaller than one hundred nanometers (<100 nm). The memory levels 16A, 16B are communicatively coupled with the substrate circuit OK through contact vias 1av, 3av, which collectively form the ISP-connections 160. The contact vias 1av, 3av comprise a plurality of vias, each of which is communicatively coupled with the vias above and below. The size of the contact vias (e.g. 1av, 3av) is preferably comparable to the width of the address lines (e.g. 1a, 2a). For example, the size of the contact vias could be equal to or twice as much as the width of the address lines. At present, the size of the contact vias (e.g. 1av, 3av) is typically smaller than one hundred nanometers (<100 nm). Apparently, the ISP-connections 160 do not penetrate the semiconductor substrate 0.

The 3D-NVM_{H} arrays 170 in FIG. 2A are 3D-W arrays. Its memory cell 7aa comprises a programmable layer 5 and a diode (also known as selector or other names) layer 6. The programmable layer 5 could be an antifuse layer (which can be programmed once and used for the 3D-OTP); or, a resistive RAM (RRAM) layer or phase-change material (PCM) layer (which can be re-programmed and used for the 3D-MTP). The diode layer 6 is broadly interpreted as any layer whose resistance at the read voltage is substantially lower than when the applied voltage has a magnitude smaller than or polarity opposite to that of the read voltage. The diode could be a semiconductor diode (e.g. p-i-n silicon diode), or a metal-oxide (e.g. TiO₂) diode.

The 3D-NVM_{H} arrays 170 in FIG. 2B are 3D-P arrays. It has at least two types of memory cells: a high-resistance memory cell 7aa, and a low-resistance memory cell 7ac. The low-resistance memory cell 7ac comprises a diode layer 6, which is similar to that in the 3D-W; whereas, the high-resistance memory cell 5aa comprises at least a high-resistance layer 9, which could simply be a layer of insulating dielectric (e.g. silicon oxide, or silicon nitride). It can be physically removed at the location of the low-resistance memory cell 7ac during manufacturing.

In FIGS. 2C-2D, the preferred pattern processor 100 comprises a substrate circuit OK and a plurality of 3D-NVM_{V} arrays 170 vertically stacked thereon. The substrate circuit OK is similar to those in FIGS. 2A-2B. The 3D-NVM_{V} array 170 comprises a plurality of vertically stacked horizontal address lines 15. The 3D-NVM_{V} array 170 also comprises a set of vertical address lines, which are perpendicular to the surface of the substrate 0. The 3D-NVM_{V} has the largest storage density among semiconductor memories. For reason of simplicity, the ISP-connections (e.g. contact vias) 160 between the 3D-NVM_{V} arrays 170 and the substrate circuit OK are not shown. They are similar to those in the 3D-NVM_{H} arrays 170 and well known to those skilled in the art.

The preferred 3D-NVM_{V} array 170 in FIG. 2C is based on vertical transistors or transistor-like devices. It comprises a plurality of vertical memory strings 16X, 16Y placed side-by-side. Each memory string (e.g. 16Y) comprises a plurality of vertically stacked memory cells (e.g. 18ay-18hy). Each memory cell (e.g. 18fy) comprises a vertical transistor, which includes a gate (acts as a horizontal address line) 15, a storage layer 17, and a vertical channel (acts as a vertical address line) 19. The storage layer 17 could comprise oxide-nitride-oxide layers, oxide-poly silicon-oxide layers, or the like. This preferred 3D-NVM_{V} array 170 is a 3D-NAND and its manufacturing details are well known to those skilled in the art.

The preferred 3D-NVM_{V} array 170 in FIG. 2D is based on vertical diodes or diode-like devices. In this preferred embodiment, the 3D-NVM_{V} array comprises a plurality of vertical memory strings 16U-16W placed side-by-side. Each memory string (e.g. 16U) comprises a plurality of vertically stacked memory cells (e.g. 18au-18hu). The 3D-NVM_{V} array 170 comprises a plurality of horizontal address lines (e.g. word lines) 15 which are vertically stacked above each other. After etching through the horizontal address lines 15 to form a plurality of vertical memory wells 11, the sidewalls of the memory wells 11 are covered with a programmable layer 13. The memory wells 11 are then filled with a conductive materials to form vertical address lines (e.g. bit lines) 19. The conductive materials could comprise metallic materials or doped semiconductor materials. The memory cells 18au-18hu are formed at the intersections of the word lines 15 and the bit line 19. The programmable layer 13 could be one-time-programmable (OTP, e.g. an antifuse layer) or multiple-time-programmable (MTP, e.g. an RRAM layer).

To minimize interference between memory cells, a diode (also known as selector or other names) is preferably formed between the word line 15 and the bit line 19. In a first embodiment, this diode is the programmable layer 13 per Se, which could have an electrical characteristic of a diode. In a second embodiment, this diode is formed by depositing an extra diode layer on the sidewall of the memory well (not shown in this figure). In a third embodiment, this diode is formed naturally between the word line 15 and the bit line 19, i.e. to form a built-in junction (e.g. P-N junction, or Schottky junction). More details on the built-in diode are disclosed in U.S. patent application Ser. No. 16/137,512, filed on Sep. 20, 2018.

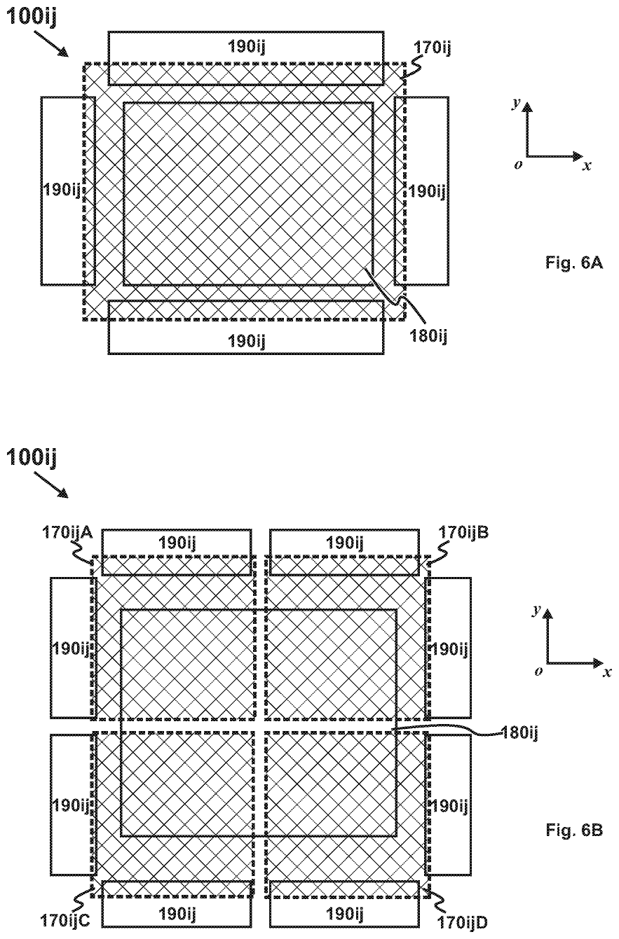

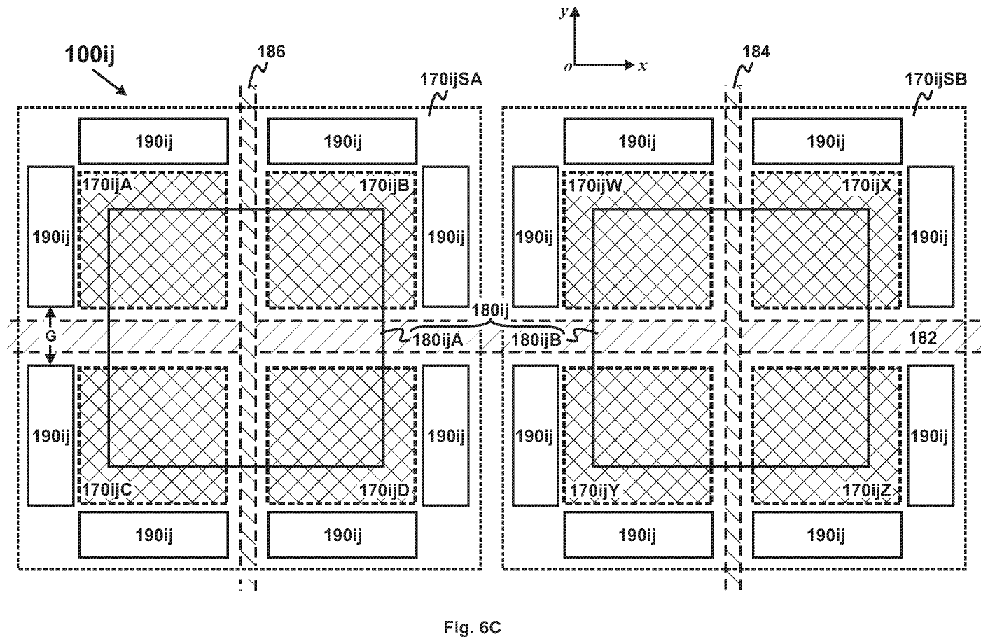

Referring now to FIG. 3, a perspective view of a preferred SPU 100ij is shown. The 3D-NVM array 170 storing patterns are vertically stacked above the substrate circuit OK. The substrate circuit OK includes the pattern-processing circuit 180 and is at least partially covered by the 3D-NVM array 170 (FIGS. 6A-6C). The 3D-NVM array 170 and the substrate circuit OK are communicatively coupled through a plurality of ISP-connections (e.g. contact vias) 160. For reason of simplicity, only a 3D-NVM_{H} array 170 is shown in this figure.

In the preferred pattern processor 100, the ISP-connections 160 (e.g. contact vias 1av, 3av) are short (on the order of one micrometer), small (comparable to the width of the address lines 1a, 2a, e.g. <100 nanometers) and numerous (a single SPU 100ij comprising at least one thousand contact vias; and, a single pattern-processing die 100 comprising at least one million contact vias), the preferred pattern processor 100 can achieve a much larger bandwidth (between 3D-NVM array 170 and pattern-processing circuit 180) than the pattern scanner of Van Lunteren, whose TSV's are long (around one hundred micrometers long) and fewer (typically around one thousand TSV's in a single module). More importantly, small memory cells (e.g. 7aa, 18ay) of the 3D-M arrays 170 and small ISP-connections 160 lead to small SPU's 100ij and therefore, the preferred pattern processor 100 comprises massive number of SPU's 100aa-100mn. In one preferred embodiment, a pattern processor 100 comprises at least one thousand SPU's. In another preferred embodiment, a pattern processor 100 comprises at least ten thousand SPU's. Because these SPU's 100aa-100mn perform pattern processing simultaneously, the preferred pattern processor 100 supports massive parallelism.

Referring now to FIGS. 4A-4D, several preferred pattern-processor doublets 100 are shown. A preferred pattern-processor doublet 100 comprises a 3D-NVM die 100a and a pattern-processing die 100b bonded face-to-face. Namely, it comprises only two semiconductor substrates, i.e. a first semiconductor substrate 0M of the 3D-NVM die 100a and a second semiconductor substrate 0P of the pattern-processing die 100b. The dice 100a, 100b are placed face-to-face, i.e. the 3D-NVM die 100a faces upward (i.e. along the +z direction), while the pattern-processing die 100b is flipped so that it faces downward (i.e. along the −z direction). In the preferred pattern-processor doublet 100 of FIG. 4A, the dice 100a, 100b are bonded and communicatively coupled by a plurality of micro-bumps 160x, which collectively realize the ISP-connections 160.

In the preferred pattern-processor doublet 100 of FIG. 4B, a first dielectric layer 168a is deposited on top of the 3D-NVM die 100a and first vias 160za are etched and filled in the first dielectric layer 168a. Then a second dielectric layer 168b is deposited on top of the pattern-processing die 100b and second vias 160zb are etched and filled in the second dielectric layer 168b. After flipping the pattern-processing die 100b and aligning the first and second vias 160za, 160zb, the 3D-NVM and pattern-processing dice 100a, 100b are bonded. Finally, the 3D-NVM and pattern-processing dice 100a, 100b are communicatively coupled by the contacted first and second vias 160za, 160zb, which collectively realizes the ISP-connections 160. In this preferred embodiment, the first and second vias 160za, 160zb are also referred to as vertical interconnect accesses (VIA's).

The preferred 3D-NVM die 100a in FIG. 4C is similar to that in FIG. 2C. It is a 3D-NAND. It should be apparent to those skilled in the art that other types of the 3D-NVM (e.g. those disclosed in FIGS. 2A-2B, 2D) can be used. The preferred 3D-NVM die 100 also comprises a substrate circuit 0Ka, upon which the 3D-NVM array 170 is formed. The transistors 0t are disposed on a first semiconductor substrate 0a and communicatively coupled by the substrate interconnects 0ia. The substrate interconnects 0ia include two interconnect layers 0m1a-0m2a, each of which comprises a plurality of interconnects (e.g. 0m) on a same physical plane. In this figure, the substrate circuit 0Ka could comprise the peripheral circuits of the 3D-NVM arrays 170. Alternatively, the substrate circuit 0Ka does not comprise full peripheral circuits of the 3D-NVM arrays 170. Namely, at least a portion of the peripheral circuits is formed in the pattern-processing die 100b of FIG. 4D.

In FIG. 4C, the 3D-NVM array 170 includes eight address-line layers 0a1a-0a8a. Each address-line layer (e.g. 0a1a) comprises a plurality of address lines on a same physical plane. These address-line layers 0a1a-0a8a form eight memory levels. Since they are formed above (not in contact with or interposed therebetween by) the first semiconductor substrate 0M, the memory cells (e.g. 18ay-18hy) of the 3D-NVM array 170 do not comprise any single-crystalline semiconductor material.

The preferred pattern-processing die 100b in FIG. 4D is a conventional 2-D circuit 0Kb comprising transistors 0t and interconnects 0ib. The transistors 0t are formed on a second semiconductor substrate 0b and communicatively coupled by the interconnects 0ib. In this embodiment, the interconnects 0ib comprises four interconnect layers 0m1b-0m4b. Each interconnect layer (e.g. 0m1b) comprises a plurality of interconnects (e.g. 0m) on a same physical plane. Formed on a single-crystalline semiconductor substrate 0P, the pattern-processing circuit 180 comprises at least a single-crystalline semiconductor material.

In the preferred pattern-processor doublet 100, the 3D-NVM die 100a comprises substantially more back-end-of-line (BEOL) layers (including all interconnect layers and all address-line layers) than the pattern-processing die 100b. For example, the 3D-NVM die 100a in FIG. 4C comprises ten BEOL layers (0m1a-0m2a, 0a1a-0a8a), while the pattern-processing die 100b in FIG. 4D comprises only four BEOL layers (0m1b-0m4b). Since the 3D-NVM die 100a is more expensive than the pattern-processing die 100b, it is preferred to dispose at least a portion of the peripheral circuits of the 3D-NVM arrays on the pattern-processing die 100b. Furthermore, designed and manufactured independently, the pattern-processing die 100 could comprise more interconnect layers than the 3D-NVM die 100a. For example, the pattern-processing die 100b of FIG. 4D comprises four interconnect layers (0m1b-0m4b), while the 3D-NVM die 100a of FIG. 4C comprises only two interconnect layers (0m1a-0m2a). As a result, the circuit layout on the pattern-processing die 100b is much easier than the 3D-NVM die 100a. Moreover, the pattern-processing die 100b may comprise high-speed interconnect materials (e.g. copper), while the substrate circuit 0ia of the 3D-NVM die 100a could only use high-temperature interconnect materials (e.g. tungsten), which generally are slower.

Similar to the preferred pattern-processor die 100 of FIGS. 2A-3, the ISP-connections 160 (e.g. micro-bumps 160x of FIG. 4A, VIA's in FIG. 4B) in the pattern-processor doublets 100 do not penetrate through any semiconductor substrate. Because they are not separated by any semiconductor substrate, the 3D-NVM array 170 and the pattern-processing circuit 180 are physically close to each other. Thus, the ISP-connections 160 are short, small, and numerous. In one preferred embodiment, the length of the ISP-connections 160 is on the order of one micrometer; the diameter of the ISP-connections 160 is between 40 nanometers to one micrometer; and, the number of the ISP-connections 160 is more than one thousand in each SPU and more than one million for the preferred pattern-processor doublet 100; and/or, the number of the SPU's in the preferred pattern-processor doublet 100 is more than one thousand. Accordingly, the preferred pattern-processor doublet 100 can realize a large bandwidth between the 3D-NVM array 170 and the pattern-processing circuit 180. In addition, the preferred pattern-processor doublet 100 can achieve massive parallelism to offset the large latency of the 3D-NVM array 170.

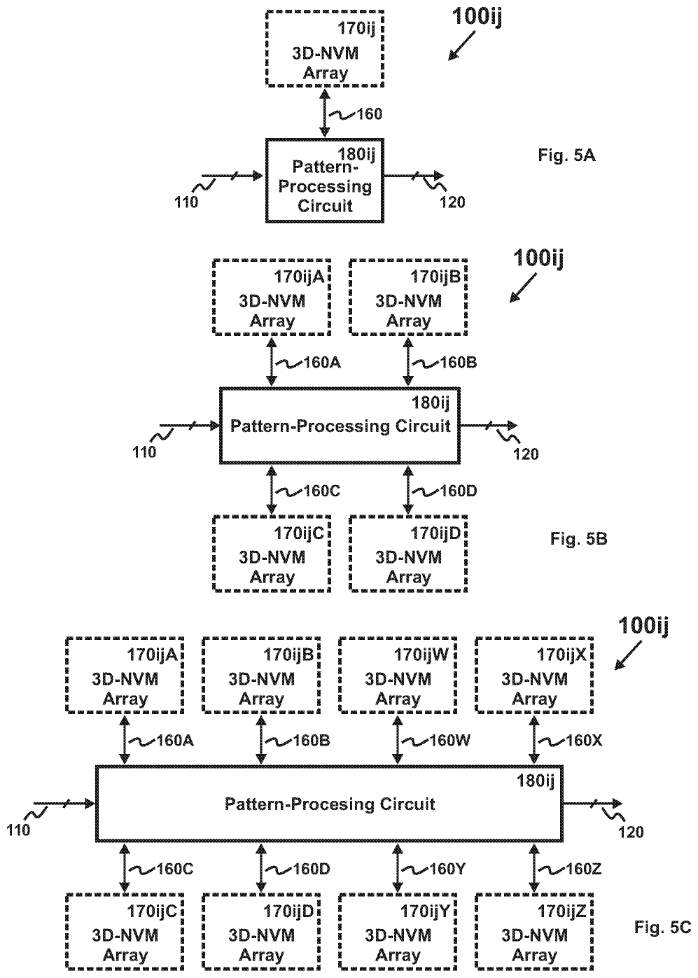

Referring now to FIGS. 5A-6C, three preferred SPU's 100ij are shown. FIGS. 5A-5C are their circuit block diagrams and FIGS. 6A-6C are their circuit layout views. In these preferred embodiments, a pattern-processing circuit 180ij serves different number of 3D-NVM arrays.

In FIG. 5A, each SPU 100ij comprises a single 3D-NVM array 170ij and therefore, the pattern-processing circuit 180ij serves this single 3D-NVM array 170ij, i.e. it processes the patterns stored in the 3D-NVM array 170ij. In FIG. 5B, each SPU 100ij comprises four 3D-NVM arrays 170ijA-100ijD and therefore, the pattern-processing circuit 180ij serves four 3D-NVM arrays 170ijA-170ijD, i.e. it processes the patterns stored in four 3D-NVM arrays 170ijA-170ijD. In FIG. 5C, each SPU 100ij comprises eight 3D-NVM arrays 170ijA-100ijD, 170ijW-170ijZ and therefore, the pattern-processing circuit 180ij serves eight 3D-NVM arrays 170ijA-170ijD, 170ijW-170ijZ, i.e. it processes the patterns stored in the 3D-NVM arrays 170ijA-170ijD, 170ijW-170ijZ. Because they are located on a different physical level than the pattern-processing circuit 180ij (referring to FIGS. 2A-2D), the 3D-NVM arrays 170ij-170ijZ are drawn by dashed lines.

FIGS. 6A-6C disclose the circuit layouts of the pattern-processing circuits 180, as well as the projections (in dashed lines) of the 3D-NVM arrays 170 on the substrate carrying the pattern-processing circuits 180 (i.e. the substrate 0 for the pattern-processor die 100 of FIGS. 2A-2D, or the substrate 0P for the pattern-processor doublet 100 of FIGS. 4A-4B). The embodiment of FIG. 6A corresponds to that of FIG. 5A. In this preferred embodiment, the pattern-processing circuit 180ij and the peripheral circuit 190ij of the 3D-NVM array 170ij are disposed on the substrate (0 or 0P). Their footprints and the footprints of the 3D-NVM array 170ij overlap. The ISP-connections 160 (not drawn) communicatively couple these peripheral circuits 190ij with the 3D-NVM array 170ij. Because it has a relatively small footprint, this preferred pattern-processing circuit 180ij is best for a code-matching circuit or a string-matching circuit. With each SPU 100ij containing a single 3D-M array 170ij, this preferred embodiment ensures massive parallelism.

The embodiment of FIG. 6B corresponds to that of FIG. 5B. In this preferred embodiment, the pattern-processing circuit 180ij and the peripheral circuits 190ij of the 3D-NVM arrays 170ijA-170ijD are disposed on the substrate (0 or 0P). Their footprints and the footprints of the 3D-NVM array 170ijA-170ijD overlap. Note that the peripheral circuit 190ij of the 3D-NVM array 170ijA is only disposed along two projected edges (in dashed lines) of the 3D-NVM array 170ijA on the substrate (0 or 0P); and, there is no peripheral circuit along the other two projected edges (in dashed lines) of the 3D-NVM array 170ijA. In the meantime, the ISP-connections 160 (not drawn) communicatively couple these peripheral circuits 190ij with the associated 3D-NVM array 170ijA. Similar designs are made to other 3D-NVM arrays 170ijB-170ijD. This is to accommodate the layout of the pattern-processing circuit 180ij. Because it has a large size, this preferred pattern-processing circuit 180ij is best for a code-matching circuit, a string-matching circuit, a simple speech-recognition circuit, or a simple image-recognition circuit.

The embodiment of FIG. 6C corresponds to that of FIG. 5C. The 3D-NVM arrays 170ijA-170ijD, 170ijW-170ijZ are divided into two sets: a first set 170ijSA includes four 3D-NVM arrays 170ijA-170ijD, and a second set 170ijSB includes four 3D-NVM arrays 170ijW-170ijZ. Below (or, above) the four 3D-NVM arrays 170ijA-170ijD of the first set 170ijSA, a first component 180ijA of the pattern-processing circuit 180ij can be laid out. Similarly, below (or, above) the four 3D-NVM arrays 170ijW-170ijZ of the second set 170ijSB, a second component 180ijB of the pattern-processing circuit 180ij can be laid out. The first and second components 180ijA, 180ijB collectively form the pattern-processing circuit 180ij. In this embodiment, adjacent peripheral circuits 190ij of the 3D-NVM arrays are separated by physical gaps (e.g. G) for forming the routing channel 182, 184, 186, which provide coupling between different components 180ijA, 180ijB, or between different pattern-processing circuits. Because it is located under (or, above) eight 3D-NVM arrays 170ijA-170ijD and 170ijW-170ijZ, this preferred pattern-processing circuit 180ij is even larger and therefore, can be used for a speech-recognition circuit or an image-recognition circuit. Note that the peripheral circuit 190ij of each 3D-NVM array is only disposed along two projected edges thereof (in dashed lines) on the substrate (0 or 0P); and, there is no peripheral circuit along the other two projected edges thereof (in dashed lines). In the meantime, the ISP-connections 160 (not drawn) communicatively couple these peripheral circuits 190ij with the associated 3D-NVM arrays.

Accordingly, the present invention further discloses a 3-D processor including a plurality of storage-processing units (SPU's), each of said SPU's comprising: a single processing circuit disposed on a semiconductor substrate; at least first and second three-dimensional non-volatile memory (3D-NVM) arrays including memory cells not in contact with said semiconductor substrate, said first 3D-NVM array having first and second projected edges on said semiconductor substrate, said second 3D-NVM array having third and fourth projected edges on said semiconductor substrate; a plurality of inter-storage-processor (ISP) connections for communicatively coupling said first and second 3D-NVM arrays and said processing circuit; wherein the footprints of said first and second 3D-NVM arrays and said processing circuit at least partially overlap; a first peripheral circuit of said first 3D-NVM array is disposed around said first projected edge on said semiconductor substrate; a second peripheral circuit of said second 3D-NVM array is disposed around said third projected edge on said semiconductor substrate; no peripheral circuits are disposed along said projected second and fourth edges on said semiconductor substrate.

The preferred pattern processor 100 could be either processor-like or storage-like. The processor-like pattern processor 100 is a 3-D processor with an embedded search-pattern library (or simply, a 3-D processor). The preferred 3-D processor could be either a 3-D processor die (FIGS. 2A-3) or a 3-D processor doublet (FIGS. 4A-4D). It searches a target pattern (from the input bus 110) against the embedded search-pattern library. To be more specific, the 3D-NVM array 170 stores at least a portion of the embedded search-pattern library (e.g. a virus library, a keyword library, an acoustic/language model library, an image model library); at least a portion of a target pattern (e.g. a network packet, a digital file, audio data, or image data) is sent to the SPU's 100aa-100mn via the input bus 110; the pattern-processing circuit 180 performs pattern processing. Because massive number of the SPU's 100aa-100mn support massive parallelism while the ISP-connections 160 supports a large bandwidth, the preferred 3-D processor can achieve a high throughput.

Accordingly, the present invention discloses a 3-D processor, comprising an input bus for transferring at least a first portion of a target pattern and at least one thousand storage-processing units (SPU's) communicatively coupled with said input bus, each of said SPU's comprising: at least a three-dimensional non-volatile memory (3D-NVM) array including memory cells and storing at least a second portion of a search pattern, wherein said memory cells are not in contact with and not interposed therebetween by any semiconductor substrate; and, said memory cells do not comprise any single-crystalline semiconductor material; a single pattern-processing circuit disposed on a semiconductor substrate and performing pattern processing for said search and target patterns, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate.

The storage-like pattern processor 100 is a 3-D memory with in-situ pattern-processing capabilities (or simply, a searchable 3-D memory). The preferred searchable 3-D memory 100 could be either a searchable 3-D memory die (FIGS. 2A-3) or a searchable 3-D memory doublet (FIGS. 4A-4D). Its primary purpose is to store a target-pattern database, with a secondary purpose of searching the stored target-pattern database for a search pattern specified by a user. To be more specific, a target-pattern database (e.g. a collection of digital files, a big-data database/archive, an audio database/archive, an image database/archive) is stored and distributed in the 3D-NVM arrays 170; at least a portion of a search pattern (e.g. a virus signature, a keyword, a model) is sent to the SPU's 100aa-100mn via the input bus 110; the pattern-processing circuit 180 searches the search pattern in the target-pattern database. Because massive number of the SPU's 100aa-100mn support massive parallelism while the ISP-connections 160 supports a large bandwidth, the preferred searchable 3-D memory 100 can achieve a high throughput.

In the preferred searchable 3-D memory 100, because each SPU 100ij contains a pattern-processing circuit 180, the data stored in its 3D-NVM array(s) 170 can be individually searched by the local pattern-processing circuit 180. No matter how large is the capacity of the searchable 3-D memory, the search time for the whole searchable 3-D memory 100 is similar to that for a single SPU 100ij. Accordingly, most searches can be completed within seconds.

Besides a substantial speed advantage, the preferred searchable 3-D memory 100 provides a substantial cost advantage. The peripheral circuits (e.g. 190ij) of the 3D-NVM array(s) 170 and the pattern-processing circuit 180 are formed on a substrate 0 (FIGS. 2A-2D) or 0P (FIGS. 4A-4B) underneath or above the 3D-NVM array(s) 170. Because the peripheral circuits (e.g. 190ij) of the 3D-NVM array(s) 170 only occupy a small portion of the substrate area, most substrate area can be used to form the pattern-processing circuits 180. As the peripheral circuits (e.g. 190ij) of the 3D-NVM arrays 170 need to be formed anyway, the pattern-processing circuits 180 can piggyback on the peripheral circuits (e.g. 190ij), i.e. they can be manufactured at the same time with the peripheral circuits (e.g. 190ij). Hence, inclusion of the pattern-processing circuits 180 adds little or no extra cost to the preferred 3-D searchable memory 100. In prior art, inclusion of the pattern-processing circuits require an extra die (e.g. Van Lunteren) or an extra die area, both of which increase cost.

The preferred searchable 3-D memory 100 provides with a substantial speed advantage (i.e. search time does not increase with capacity) and a substantial cost advantage (i.e. the in-situ searching capabilities does not incur extra cost). Accordingly, the present invention discloses a searchable 3-D memory, comprising an input bus for transferring at least a first portion of a search pattern and at least one thousand storage-processing units (SPU's) communicatively coupled with said input bus, each of said SPU's comprising: at least a three-dimensional non-volatile memory (3D-NVM) array including memory cells and storing at least a second portion of a target pattern, wherein said memory cells are not in contact with and not interposed therebetween by any semiconductor substrate; and, said memory cells do not comprise any single-crystalline semiconductor material; a single pattern-processing circuit disposed on a semiconductor substrate and performing pattern processing for said search and target patterns, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate.

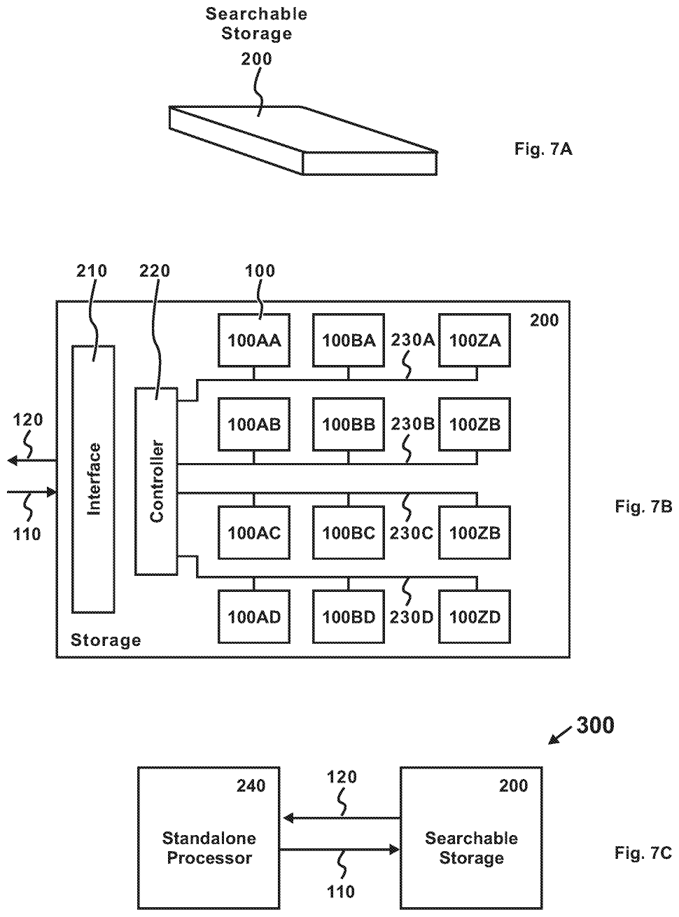

Referring now to FIGS. 7A-7C, a preferred searchable storage and an associated storage system are shown. FIG. 7A is a perspective view of the preferred searchable storage 200. Its external shape is similar to a storage card (e.g. an SD card, a CF card, or a TF card) or a solid-state drive (i.e. SSD). FIG. 7B is a circuit block diagram of the preferred searchable storage 200. It comprises an interface 210, a controller 220 and a plurality of channels 230A-230D. The interface 210 and controller 220 are well known to those skilled in the art. Each channel (e.g. 230A) includes a plurality of the preferred searchable 3-D memories 100AA-100ZA. The preferred searchable 3-D memories could be either searchable 3-D memory dice or searchable 3-D memory doublets. Each of the preferred searchable 3-D memories 100AA-100ZD stores at least a portion of data for a target-pattern database. More importantly, all of the searchable 3-D memories 100AA-100ZD have in-situ searching capabilities. This is different from the conventional storage, where each flash memory die is a pure memory and does not have any in-situ searching capabilities.

In a searchable storage 200, the search time for the whole storage 200 is irrelevant to its capacity. Most searches can be completed within seconds. In comparison, for the conventional von Neumann architecture, the processor (e.g. CPU) and the storage (e.g. HDD or SSD) are physically separated. They are communicatively coupled by a system bus. During search, data need to be read out from the storage first. Because of the limited bandwidth of the system bus, the search time is proportional to the storage capacity. In general, the search time ranges from minutes to hours, even longer. Apparently, the preferred searchable storage 200 offers substantial speed advantages.

This speed advantage can be further viewed from the perspective of parallelism. Because each SPU 100ij has its own pattern-processing circuit 180ij, the number of the SPU's grows with the storage capacity, so does the degree of parallelism. As a result, the search time does not increase with the storage capacity. However, for Van Lunteren, because the number of the SPU's and the degree of parallelism are fixed, the search time increases with the storage capacity.

In sum, considering the speed and cost advantages of the preferred searchable 3-D memory 100, the preferred searchable storage 200 provides with a substantial speed advantage (i.e. search time does not increase with the storage capacity) and a substantial cost advantage (i.e. the in-situ searching capabilities does not incur extra cost).

Due to layout constraints, the pattern-processing circuit 180 in the preferred searchable storage 200 has limited functionalities. The preferred searchable storage 200 preferably works with an external processor for full pattern processing. Accordingly, the present invention discloses a storage system 300. FIG. 7C is its circuit block diagram. It comprises a searchable storage 200 and a standalone processor 240 communicatively coupled with a system bus including an input bus 110 and an output bus 120. The standalone processor 240 could be a full-power processor which can perform full pattern processing. It could be a CPU, a GPU, an FPGA, an AI processor, or others. The pattern-processing circuit 180 in the preferred searchable storage 200 performs preliminary pattern processing. After this preliminary pattern-processing step, a fraction of data stored in the searchable storage 200 is outputted to the standalone processor 240 to perform full pattern processing. Because the amount of the data output from the preferred searchable storage 200 is substantially smaller than the amount of the data stored in the preferred searchable storage 200, this data-transfer process places less burden on the output bus 120. With much less data to process, the full pattern processing, even for the full searchable storage 200, takes less time and becomes more efficient.

In the following paragraphs, applications of the preferred pattern processor 100 are described. The fields of applications include: A) information security; B) big-data analytics; C) speech recognition; and D) image recognition. Examples of the applications include: a) information-security processor; b) anti-virus storage; c) data-analysis processor; d) searchable big-data storage; e) speech-recognition processor; f) searchable audio storage; g) image-recognition processor; h) searchable image storage.

A) Information Security

Information security includes network security and computer security. To enhance network security, the network packets needs to be scanned for viruses. Similarly, to enhance computer security, the digital files (including computer files and/or computer software) needs to be scanned for viruses. Generally speaking, virus (also known as malware) includes network viruses, computer viruses, software that violates network rules, document that violates document rules and others. During virus scan, a network packet or a digital file is compared against the virus patterns (including virus signatures, network rules, document rules, and others) in a virus library. Once a match is found, the portion of the network packet or the digital file which contains the virus is quarantined or removed.

Nowadays, the virus library has become large. It has reached hundreds of megabytes and is still growing. On the other hand, the data that require virus scan are even larger, typically on the order of gigabytes to terabytes, or even bigger. On the other hand, each processor core in the conventional processor can typically check a single virus pattern once. With a limited number of cores (e.g. tens to hundreds), the conventional processor can achieve limited parallelism for virus scan. Furthermore, because the processor is physically separated from the storage in the von Neumann architecture, it takes a long time to fetch new virus patterns. As a result, the conventional processor and its associated architecture have a poor performance for information security.

To enhance information security, the present invention discloses an information-security processor (i.e. a processor for enhancing information security), as well as an anti-virus storage (i.e. a storage with in-situ virus-scanning capabilities).

a) Information-Security Processor

To enhance information security, the present invention discloses an information-security processor 100. It searches a network packet or a digital file for various virus patterns in a virus library. If there is a match with a virus pattern, the network packet or the digital file is considered being infected by the virus. The preferred information-security processor 100 can be installed as a standalone processor in a network or a computer; or, integrated into a network processor, a computer processor, or a computer storage.

In the preferred information-security processor 100, the 3D-NVM arrays 170 in different SPU 100ij store different virus patterns. In other words, the virus library is stored and distributed in the SPU's 100aa-100mn of the preferred information-security processor 100. Once a network packet or a digital file is received on the input bus 110, at least a portion thereof is sent to the SPU's 100aa-100mn. In each SPU 100ij, the pattern-processing circuit 180 compares said portion of the network packet or the digital file against the virus patterns stored in the local 3D-NVM array 170.

The above virus-scan operations are carried out by the SPU's 100aa-100mn at the same time. Because it comprises massive number of SPU's 100aa-100mn (thousands or even more), the preferred information-security processor 100 achieves massive parallelism for virus scan. Furthermore, because the ISP-connections 160 are numerous and the pattern-processing circuit 180 is physically close to the 3D-NVM arrays 170 (compared with the conventional von Neumann architecture), the pattern-processing circuit 180 can easily fetch new virus patterns from the local 3D-NVM array 170. As a result, the preferred information-security processor 100 can perform fast and efficient virus scan. In this preferred embodiment, the 3D-NVM arrays 170 storing the virus library could be 3D-P, 3D-OTP or 3D-MTP; and, the pattern-processing circuit 180 is a code-matching circuit.

Accordingly, the present invention discloses an information-security processor, comprising an input bus for transferring at least a portion of a network packet or a digital file, and at least one thousand storage-processing units (SPU's) communicatively coupled with said input bus, each of said SPU's comprising: at least a three-dimensional non-volatile memory (3D-NVM) array including memory cells and storing at least a portion of a virus pattern, wherein said memory cells are not in contact with and not interposed therebetween by any semiconductor substrate; and, said memory cells do not comprise any single-crystalline semiconductor material; a single code-matching circuit disposed on a semiconductor substrate and searching said virus pattern in said portion of said network packet or digital file, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate.

b) Anti-Virus Storage

Whenever a new virus is discovered, the whole storage (e.g. a hard-disk drive, a solid-state drive) of the computer needs to be scanned against the new virus. This full-storage scan process is challenging to the conventional von Neumann architecture. It takes a long time to even read out all data, let alone scan virus for them. For the conventional von Neumann architecture, the full-storage scan time is proportional to the total capacity of the storage.

To shorten the full-storage scan time, the present invention discloses an anti-virus storage. It is a searchable storage 200, which has in-situ virus-scanning capabilities. To be more specific, its primary function is a storage, with in-situ virus-scanning capabilities as its secondary function. Like the flash memory dice in an SSD, a large number of the preferred searchable 3-D memories 100 can be packaged into the preferred anti-virus storage 200 (e.g. an anti-virus storage card or an anti-virus solid-state drive).

In each searchable 3-D memory 100 of the preferred anti-virus storage 200, the 3D-NVM arrays 170 in different SPU's 100aa-100mn store different portions of the digital files. In other words, digital files are stored and distributed in the SPU's 100aa-100mn of the searchable 3-D memories 100 in the preferred anti-virus storage 200. Once a new virus is discovered and a full-storage scan is required, the virus pattern of the new virus is sent via the input bus 110 to the SPU's 100aa-100mn, where the pattern-processing circuit 180 compares the data stored in the local 3D-NVM array 170 against the virus pattern.

The above virus-scan operations are carried out by the SPU's 100aa-100mn at the same time. Because of the massive parallelism, no matter how large is the capacity of the preferred anti-virus storage 200, the virus-scan time for the whole storage 200 is more or less a constant, which is close to the virus-scan time for a single SPU 100ij and generally within seconds. On the other hand, the conventional full-storage scan takes minutes to hours, or even longer. In this preferred embodiment, the 3D-NVM arrays 170 are preferably 3D-MTP; and, the pattern-processing circuit 180 is a code-matching circuit.

Accordingly, the present invention discloses an anti-virus storage, comprising an input bus for transferring at least a portion of a virus pattern, and at least one thousand storage-processing units (SPU's) communicatively coupled with said input bus, each of said SPU's comprising: at least a three-dimensional non-volatile memory (3D-NVM) array including memory cells and storing at least a portion of data, wherein said memory cells are not in contact with and not interposed therebetween by any semiconductor substrate; and, said memory cells do not comprise any single-crystalline semiconductor material; a single code-matching circuit disposed on a semiconductor substrate and searching said virus pattern in said portion of data, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate.

B) Big-Data Analytics

Big data is a term for a large collection of data, with main focus on unstructured and semi-structure data. An important aspect of big-data analytics is keyword search (including string matching, e.g. regular-expression matching). At present, the keyword library becomes large, while the big-data database is even larger. For such large keyword library and big-data database, the conventional processor and its associated architecture can hardly perform fast and efficient keyword search on unstructured or semi-structured data.

To improve the speed and efficiency of big-data analytics, the present invention discloses a data-analysis processor (i.e. a processor for performing analysis on big data), as well as a searchable storage (i.e. a storage supporting in-situ search).

c) Data-Analysis Processor

To perform fast and efficient search on big data, the present invention discloses a data-analysis processor 100. It searches the input data for the keywords from a keyword library. In the preferred data-analysis processor 100, the 3D-NVM arrays 170 in different SPU's 100aa-100mn store different keywords. In other words, the keyword library is stored and distributed in the SPU's 100aa-100mn of the preferred data-analysis processor 100. Once data are received via the input bus 110, at least a portion thereof is sent to the SPU's 100aa-100mn. In each SPU 100ij, the pattern-processing circuit 180 compares said portion of data against various keywords stored in the local 3D-NVM array 170.

The above search operations are carried out by the SPU's 100aa-100mn at the same time. Because it comprises massive number of SPU's 100aa-100mn (thousands to tens of thousands or even more), the preferred data-analysis processor 100 achieves massive parallelism for keyword search. Furthermore, because the ISP-connections 160 are numerous and the pattern-processing circuit 180 is physically close to the 3D-NVM arrays 170 (compared with the conventional von Neumann architecture), the pattern-processing circuit 180 can easily fetch keywords from the local 3D-NVM array 170. As a result, the preferred data-analysis processor 100 can perform fast and efficient search on unstructured data or semi-structured data. In this preferred embodiment, the 3D-NVM arrays 170 storing the keyword library could be 3D-P, 3D-OTP or 3D-MTP; and, the pattern-processing circuit 180 is a string-matching circuit.

Accordingly, the present invention discloses a data-analysis processor, comprising an input bus for transferring at least a portion of data, and at least one thousand storage-processing units (SPU's) communicatively coupled with said input bus, each of said SPU's comprising: at least a three-dimensional non-volatile memory (3D-NVM) array including memory cells and storing at least a portion of a keyword, wherein said memory cells are not in contact with and not interposed therebetween by any semiconductor substrate; and, said memory cells do not comprise any single-crystalline semiconductor material; a single string-matching circuit disposed on a semiconductor substrate and searching said keyword in said portion of data, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate.

d) Searchable Big-Data Storage

Big-data analytics often requires full-database search, e.g. to search a whole database for a keyword. The full-database search is challenging to the conventional von Neumann architecture. Because the database is large, with a capacity of gigabytes to terabytes, or even larger, it takes a long time to even read out all data, let alone analyze them. For the conventional von Neumann architecture, the full-database search time is proportional to the database size.

To improve the overall performance of full-database search, the present invention discloses a searchable big-data storage 200. It is a searchable storage 200, which has in-situ big-data analyzing capabilities. Its primary function is storage, with in-situ big-data analyzing (e.g. searching) capabilities as its secondary function. Like the flash memory in an SSD, a large number of the preferred searchable 3-D memories 100 can be packaged into the preferred searchable big-data storage 200.

In the searchable 3-D memory 100 of the preferred searchable big-data storage 200, the 3D-NVM arrays 170 in different SPU's 100aa-100mn store different portions of the database. In other words, the database is stored and distributed in the SPU's 100aa-100mn of the searchable 3-D memories 100 in the preferred searchable big-data storage 200. During search, a keyword is sent via the input bus 110 to the SPU's 100aa-100mn. In each SPU 100ij, the pattern-processing circuit 180 searches the portion of the database stored in the local 3D-NVM array 170 for the keyword.

The above search operations are carried out by the SPU's 100aa-100mn at the same time. Because of massive parallelism, no matter how large is the capacity of the searchable big-data storage 200, the keyword-search time for the whole storage 200 is more or less a constant, which is close to the keyword-search time for a single SPU 100ij and generally within seconds. On the other hand, the conventional full-storage search takes minutes to hours, or even longer. In this preferred embodiment, the 3D-NVM arrays 170 are preferably 3D-MTP; and, the pattern-processing circuit 100 is a string-matching circuit.

Having the largest storage density among all semiconductor memories, the 3D-NVM_{V} is particularly suitable for storing a big-data database. Among all 3D-NVM_{V}, the 3D-OTP_{V} has a long data lifetime (e.g. >100 years) and therefore, is particularly suitable for archiving. Because archives store massive data, fast searchability is very important. A searchable 3D-OTP_{V} will provide a large, inexpensive archive with fast searching capabilities.

Accordingly, the present invention discloses a searchable big-data storage, comprising an input bus for transferring at least a portion of a keyword, and at least one thousand storage-processing units (SPU's) communicatively coupled with said input bus, each of said SPU's comprising: at least a three-dimensional non-volatile memory (3D-NVM) array including memory cells and storing at least a portion of data, wherein said memory cells are not in contact with and not interposed therebetween by any semiconductor substrate; and, said memory cells do not comprise any single-crystalline semiconductor material; a single string-matching circuit disposed on a semiconductor substrate and searching said keyword in said portion of data, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate.

C) Speech Recognition

Speech recognition enables the recognition and translation of spoken language. It is primarily implemented through pattern recognition on the audio data with an acoustic/language model, which is a part of an acoustic/language model library. During speech recognition, the pattern-processing circuit 180 performs speech recognition on the audio data by finding the nearest acoustic/language model in the acoustic/language model library. Because the conventional processor (e.g. CPU, GPU, FPGA) has a limited number of cores and the acoustic/language model database is stored externally, the conventional processor and the associated architecture have a poor performance in speech recognition.

e) Speech-Recognition Processor

To improve the performance of speech recognition, the present invention discloses a speech-recognition processor 100. It performs speech recognition on the audio data using the acoustic/language models stored in a local acoustic/language library. To be more specific, the audio data is sent via the input bus 110 to the SPU's 100aa-100mn. The 3D-NVM arrays 170 store at least a portion of the acoustic/language model. In other words, an acoustic/language model library is stored and distributed in the SPU's 100aa-100mn of the preferred speech-recognition processor 100. In this preferred embodiment, the 3D-NVM arrays 170 storing the models could be 3D-P, 3D-OTP, or 3D-MTP; and, the pattern-processing circuit 180 is a speech-recognition circuit.

Accordingly, the present invention discloses a speech-recognition processor, comprising an input bus for transferring at least a portion of audio data, and at least one thousand storage-processing units (SPU's) communicatively coupled with said input bus, each of said SPU's comprising: at least a three-dimensional non-volatile memory (3D-NVM) array including memory cells and storing at least a portion of an acoustic/language model, wherein said memory cells are not in contact with and not interposed therebetween by any semiconductor substrate; and, said memory cells do not comprise any single-crystalline semiconductor material; a single speech-recognition circuit disposed on a semiconductor substrate and performing speech recognition on said portion of audio data with said acoustic/language model, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate.

f) Searchable Audio Storage

To enable audio search in an audio database (e.g. an audio archive), the present invention discloses a searchable audio storage. It comprises a plurality of searchable 3-D memories. An acoustic/language model derived from the audio data to be searched for is sent via the input bus 110 to the SPU's 100aa-100mn of each of the preferred searchable 3-D memories. The 3D-NVM array(s) 170 of each of the preferred searchable 3-D memories stores at least a portion of the audio database/archive. In other words, the audio database is stored and distributed in the SPU's 100aa-100mn of the preferred searchable audio storage. The pattern-processing circuit 180 performs speech recognition on the audio data stored in the 3D-NVM arrays 170 with the acoustic/language model from the input bus 110. In this preferred embodiment, the 3D-NVM arrays 170 storing the audio database are preferably 3D-MTP; and, the pattern-processing circuit 180 is a speech-recognition circuit.

Accordingly, the present invention discloses a searchable audio storage, comprising an input bus for transferring at least a portion of an acoustic/language model, and at least one thousand storage-processing units (SPU's) communicatively coupled with said input bus, each of said SPU's comprising: at least a three-dimensional non-volatile memory (3D-NVM) array including memory cells and storing at least a portion of audio data, wherein said memory cells are not in contact with and not interposed therebetween by any semiconductor substrate; and, said memory cells do not comprise any single-crystalline semiconductor material; a single speech-recognition circuit disposed on a semiconductor substrate and performing speech recognition on said portion of audio data with said acoustic/language model, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate.

D) Image Recognition

Image recognition enables the recognition of images. It is primarily implemented through pattern recognition on image data with an image model, which is a part of an image model library. During image recognition, the pattern-processing circuit 180 performs image recognition on the image data by finding the nearest image model in the image model library. Because the conventional processor (e.g. CPU, GPU, FPGA) has a limited number of cores and the image model database is stored externally, the conventional processor and the associated architecture have a poor performance in image recognition.

g) Image-Recognition Processor

To improve the performance of image recognition, the present invention discloses an image-recognition processor 100. It performs image recognition on the image data using the image models stored in a local image library. To be more specific, the image data is sent via the input bus 110 to the SPU's 100aa-100mn. The 3D-NVM arrays 170 store at least a portion of the image model. In other words, an image model library is stored and distributed in the SPU's 100aa-100mn. In this preferred embodiment, the 3D-NVM arrays 170 storing the models could be 3D-P, 3D-OTP, or 3D-MTP; and, the pattern-processing circuit 180 is an image-recognition circuit.

Accordingly, the present invention discloses an image-recognition processor, comprising an input bus for transferring at least a portion of image data, and at least one thousand storage-processing units (SPU's) communicatively coupled with said input bus, each of said SPU's comprising: at least a three-dimensional non-volatile memory (3D-NVM) array including memory cells and storing at least a portion of an image model, wherein said memory cells are not in contact with and not interposed therebetween by any semiconductor substrate; and, said memory cells do not comprise any single-crystalline semiconductor material; a single image-recognition circuit disposed on a semiconductor substrate and performing image recognition on said portion of image data with said image model, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate.

h) Searchable Image Storage

To enable image search in an image database (e.g. an image archive), the present invention discloses a searchable image storage. It comprises a plurality of searchable 3-D memories. An image model derived from the image data to be searched for is sent via the input bus 110 to the SPU's 100aa-100mn of each of the preferred searchable 3-D memories. The 3D-NVM array(s) 170 of each of the preferred searchable 3-D memories stores at least a portion of the image database/archive. In other words, the image database is stored and distributed in the SPU's 100aa-100mn of the preferred searchable image storage. The pattern-processing circuit 180 performs image recognition on the image data stored in the 3D-NVM arrays 170 with the image model from the input bus 110. In this preferred embodiment, the 3D-NVM arrays 170 storing the image database are preferably 3D-MTP; and, the pattern-processing circuit 180 is an image-recognition circuit.

Accordingly, the present invention discloses a searchable image storage, comprising an input bus for transferring at least a portion of an image model, and at least one thousand storage-processing units (SPU's) communicatively coupled with said input bus, each of said SPU's comprising: at least a three-dimensional non-volatile memory (3D-NVM) array including memory cells and storing at least a portion of image data, wherein said memory cells are not in contact with and not interposed therebetween by any semiconductor substrate; and, said memory cells do not comprise any single-crystalline semiconductor material; a single image-recognition circuit disposed on a semiconductor substrate and performing image recognition on said portion of image data with said image model, wherein said pattern-processing circuit comprises at least a single-crystalline semiconductor material; a plurality of inter-storage-processor (ISP) connections for communicatively coupling said 3D-NVM array and said pattern-processing circuit, wherein said ISP-connections do not penetrate through any semiconductor substrate.

While illustrative embodiments have been shown and described, it would be apparent to those skilled in the art that many more modifications than that have been mentioned above are possible without departing from the inventive concepts set forth therein. The invention, therefore, is not to be limited except in the spirit of the appended claims.

1-23. (canceled)

24. A pattern processor, comprising a single-crystalline semiconductor substrate, an input bus for transferring at least a first portion of a first pattern, and a plurality of storage-processing units (SPU's) communicatively coupled with said input bus, each of said SPU's comprising:
at least a three-dimensional non-volatile memory (3D-NVM) array including memory cells for storing at least a second portion of a second pattern, wherein said memory cells are neither in contact with nor interposed therebetween by any semiconductor substrate including said single-crystalline semiconductor substrate; and, said memory cells do not comprise any single-crystalline semiconductor material;
a pattern-processing circuit and at least a portion of a peripheral circuit of said 3D-NVM array disposed on said single-crystalline semiconductor substrate, wherein said pattern-processing circuit performs pattern processing for said first and second patterns; said peripheral circuit is communicatively coupled with said pattern-processing circuit; and, said pattern-processing circuit and said portion of said peripheral circuit comprise at least a single-crystalline semiconductor material;
a plurality of inter-storage-processor (ISP) connections for communicatively coupling said memory cells and said peripheral circuit, wherein said ISP-connections do not penetrate through any semiconductor substrate including said single-crystalline semiconductor substrate; and, said memory cells and said pattern-processing circuit at least partially overlap.

25. The processor according to claim 24, wherein said pattern processor comprises at least one thousand SPU's.

26. The processor according to claim 25, wherein said pattern processor comprises at least ten thousand SPU's.

27. The processor according to claim 24, wherein each of said SPU's comprises at least one thousand ISP connections; and/or, the length of said ISP connections is on the order of a micron.

28. The pattern processor according to claim 24 being a pattern-processor singlet, comprising no more semiconductor substrate other than said single-crystalline semiconductor substrate.

29. The pattern processor according to claim 24 being a pattern-processor doublet, further comprising:
a pattern-processing die including said pattern-processing circuit and said portion of said peripheral circuit disposed on said single-crystalline semiconductor substrate;
a 3D-NVM die including said 3D-NVM array disposed on another semiconductor substrate different from said single-crystalline semiconductor substrate;
wherein said 3D-NVM die and said pattern-processing die are face-to-face bonded; and, said pattern-processor doublet includes only two semiconductor substrates consisting of said single-crystalline semiconductor substrate and said another semiconductor substrate.

30. The pattern processor according to claim 24, wherein
said input bus transfers at least a portion of a network packet or a digital file;
said memory cells store at least a portion of a virus pattern;
said pattern-processing circuit is a code-matching circuit for searching said virus pattern in said network packet or said digital file.

31. The pattern processor according to claim 24, wherein
said input bus transfers at least a portion of data;
said memory cells store at least a portion of a keyword;
said pattern-processing circuit is a string-matching circuit for searching said keyword in said portion of data.

32. The pattern processor according to claim 24, wherein
said input bus transfers at least a portion of audio data;
said memory cells store at least a portion of an acoustic/language model;
said pattern-processing circuit is a speech-recognition circuit for performing speech recognition on said portion of audio data with said acoustic/language model.

33. The pattern processor according to claim 24, wherein
said input bus transfers at least a portion of image data;
said memory cells store at least a portion of an image model;
said pattern-processing circuit is an image-recognition circuit for performing image recognition on said portion of image data with said image model.

34. The pattern processor according to claim 24, wherein
said input bus transfers at least a portion of a virus pattern;
said memory cells store at least a portion of data;
said pattern-processing circuit is a code-matching circuit for searching said virus pattern in said portion of data.

35. The pattern processor according to claim 24, wherein
said input bus transfers at least a portion of a keyword;
said memory cells store at least a portion of data;
said pattern-processing circuit is a string-matching circuit for searching said keyword in said portion of data.

36. The pattern processor according to claim 24, wherein
said input bus transfers at least a portion of an acoustic/language model;
said memory cells store at least a portion of audio data;
said pattern-processing circuit is a speech-recognition circuit for performing speech recognition on said portion of audio data with said acoustic/language model.

37. The pattern processor according to claim 24, wherein
said input bus transfers at least a portion of an image model;
said memory cells store at least a portion of image data;
said pattern-processing circuit is an image-recognition circuit for performing image recognition on said portion of image data with said image model.

38. A searchable storage, comprising an input bus for transferring at least a search pattern and a plurality of searchable 3-D memories communicatively coupled with said input bus, each of said searchable 3-D memories comprising a single-crystalline semiconductor substrate and a plurality of storage-processing units (SPU's) communicatively coupled with said input bus, each of said SPU's comprising:
at least a three-dimensional non-volatile memory (3D-NVM) array including memory cells for storing at least a portion of data, wherein said memory cells are neither in contact with nor interposed therebetween by any semiconductor substrate including said single-crystalline semiconductor substrate; and, said memory cells do not comprise any single-crystalline semiconductor material;
a pattern-processing circuit and at least a portion of a peripheral circuit of said 3D-NVM array disposed on said single-crystalline semiconductor substrate, wherein said pattern-processing circuit performs pattern processing for said search pattern and said portion of data; said peripheral circuit is communicatively coupled with said pattern-processing circuit; and, said pattern-processing circuit and said portion of said peripheral circuit comprise at least a single-crystalline semiconductor material;
a plurality of inter-storage-processor (ISP) connections for communicatively coupling said memory cells and said peripheral circuit, wherein said ISP-connections do not penetrate through any semiconductor substrate including said single-crystalline semiconductor substrate; and, said memory cells and said pattern-processing circuit at least partially overlap;
whereby the primary purpose of said searchable storage is long-term data storage and the secondary purpose of said searchable storage is in-situ search.

39. The searchable storage according to claim 38, wherein each of said SPU's comprises at least one thousand ISP connections; and/or, the length of said ISP connections is on the order of a micron.

40. The searchable storage according to claim 38, wherein each of said searchable 3-D memories is a singlet, comprising no more semiconductor substrate other than said single-crystalline semiconductor substrate.

41. The searchable storage according to claim 38, wherein each of said searchable 3-D memories is a doublet, further comprising:
a pattern-processing die including said pattern-processing circuit and said portion of said peripheral circuit disposed on said single-crystalline semiconductor substrate;
a 3D-NVM die including said 3D-NVM array disposed on another semiconductor substrate different from said single-crystalline semiconductor substrate;
wherein said 3D-NVM die and said pattern-processing die are face-to-face bonded; said pattern-processor doublet includes only two semiconductor substrates consisting of said single-crystalline semiconductor substrate and said another semiconductor substrate.

42. The searchable storage according to claim 38, wherein
said input bus transfers at least a portion of a virus pattern;
said memory cells store at least a portion of data;
said pattern-processing circuit is a code-matching circuit for searching said virus pattern in said portion of data.

43. The searchable storage according to claim 38, wherein
said input bus transfers at least a portion of a keyword;
said memory cells store at least a portion of data;
said pattern-processing circuit is a string-matching circuit for searching said keyword in said portion of data.

44. The searchable storage according to claim 38, wherein
said input bus transfers at least a portion of an acoustic/language model;
said memory cells store at least a portion of audio data;
said pattern-processing circuit is a speech-recognition circuit for performing speech recognition on said portion of audio data with said acoustic/language model.

45. The searchable storage according to claim 38, wherein
said input bus transfers at least a portion of an image model;
said memory cells store at least a portion of image data;
said pattern-processing circuit is an image-recognition circuit for performing image recognition on said portion of image data with said image model.

46. The searchable storage according to claim 38, wherein a fraction of said portion of data is transferred to a standalone processor for full pattern processing.
